(19) United States
(12) Patent Application Publication
(10) Pub. No.: US 2022/0406210 A1
(43) Pub. Date: Dec. 22, 2022

(54) AUTOMATIC GENERATION OF LECTURES DERIVED FROM GENERIC, EDUCATIONAL OR SCIENTIFIC CONTENTS, FITTING SPECIFIED PARAMETERS

(71) Applicant: ROOTS FOR EDUCATION LLC, São Paulo - State of São Paulo (BR)

(72) Inventors: Oswaldo LOPES DO NASCIMENTO FILHO, São Paulo (BR); Fábio RENDELUCCI, São Paulo (BR)

(21) Appl. No.: 17/748,836

(22) Filed: May 19, 2022

Related U.S. Application Data
(60) Provisional application No. 63/212,948, filed on Jun. 21, 2021.

(51) Int. Cl. G09B 5/06; G10L 15/08

(52) U.S. Cl. CPC G09B 5/06; G10L 15/083

(57) ABSTRACT

A method of generating an educational output unit includes analyzing, using a machine learning module, content based on a logic tree, generating a plurality of blocks, associating tags with each block of the plurality of blocks, and assembling the plurality of blocks into an output unit based on one or more parameters and the tags. The logic tree comprises a structural hierarchy for the content.

### CROSS-REFERENCES TO RELATED APPLICATIONS

This application claims the benefit of U.S. Provisional Application No. 63/212,948, filed on Jun. 21, 2021, and entitled “AUTOMATIC GENERATION OF LECTURES DERIVED FROM GENERIC, EDUCATIONAL OR SCIENTIFIC CONTENTS, FITTING SPECIFIED SYLLABUS—AGLFS”, which is incorporated herein by reference in its entirety for all purposes.

### BACKGROUND

Traditional learning including using text books that have lessons organized for teacher and students. The textbooks provided rigid lessons as the text within the book cannot be modified. In addition, the content of the book is selected by the publisher. As it is published, it cannot be modified for any specific group or level, much less individually.

### SUMMARY

In some embodiments, a method of generating an educational output unit comprises analyzing, using a machine learning module, content based on a logic tree, generating a plurality of blocks, associating tags with each block of the plurality of blocks, and assembling the plurality of blocks into an output unit based on one or more parameters and the tags. The logic tree comprises a structural hierarchy for the content.

In some embodiments, a method of generating an educational output unit comprises accessing, by a processor, content, wherein the content comprises information related to a subject, receiving an input comprising a logic tree, analyzing, using a machine learning module, the content based on a logic tree, generating a plurality of blocks, associating tags with each block of the plurality of blocks, and assembling the plurality of blocks into an output unit based on one or more parameters and the tags. The logic tree comprises a structural hierarchy for the content, and the plurality of blocks comprises at least two blocks from different sections of the content.

In some embodiments, a method of generating an output unit comprises receiving an input unit, receiving input parameters, and generating an output unit based on the input unit and the input parameters. The input unit comprises content, and the input parameters define need and objectives of multiple individual attendees or a group of attendees.

In some embodiments, a method of accessing a learning management system using a voice interface comprises receiving, by an application programming interface (API) of a processing system, a command from a voice assistant, passing, from the API, the command to a websocket, accepting, by the websocket, the command, receiving, by the websocket, data associated with the command, monitoring, by a system service of the processing system, the websocket, accepting, by the system service, the command and data in response to the websocket accepting the command, and performing the command using the data in response to accepting the command and data. The voice command is configured to respond to vocal input.

In some embodiments, a method of providing an output unit comprising learning materials comprises accessing a plurality of output units over an internet connection, caching the plurality of output units in a local storage, ceasing the internet connection so that the internet connection is offline, accessing and displaying one or more of the plurality of output units while the internet connection is offline, and storing user input while the internet connection is offline. Each output unit of the plurality of output units comprise learning materials.

These and other features will be more clearly understood from the following detailed description taken in conjunction with the accompanying drawings and claims.

### BRIEF DESCRIPTION OF THE DRAWINGS

The following figures illustrate embodiments of the subject matter disclosed herein. The claimed subject matter may be understood by reference to the following description taken in conjunction with the accompanying figures, in which:

FIG. 1A FIG. 1B are diagrams illustrating relational structures of the classification of the main entities according to some embodiments.

FIG. 2 illustrates an exemplary subject matter listing used to identify the initial master blocks according to some embodiments.

FIG. 3 illustrates a flow chart of a process to provide tags to entities according to some embodiments.

FIG. 4 illustrates a flow chart of another process to provide tags to entities according to some embodiments.

FIG. 5 illustrates a flow chart of still another process to provide tags to entities according to some embodiments.

FIGS. 6A-6C illustrate exemplary flow charts of searching processes and determinations of relevance between entities according to some embodiments.

FIG. 7 is a diagram illustrating a relational structure of the database of entities according to some embodiments.

FIG. 8 is a diagram illustrating logical components of a pedagogical kernel and its hierarchy according to some embodiments.

FIG. 9 illustrates a chart showing an organizational structure of classes according to some embodiments.

FIG. 10 illustrates a chart showing an organizational structure of a syllabus according to some embodiments.

FIG. 11 is a diagram illustrating the general scheme of the system according to some embodiments.

FIG. 12 is a diagram illustrating the components of courses of entities and its hierarchy according to some embodiments.

FIG. 13 is a diagram illustrating the main features of the attendee profile tracker according to some embodiments.

FIG. 14 schematically illustrates an example of the type of outcomes associated with the decision algorithm according to some embodiments.

FIG. 15 is a diagram illustrating the use of voice commands according to some embodiments.

FIG. 16 illustrates an exemplary identification process for a user according to some embodiments.

FIG. 17 is a schematic representation of logical pages used in an offline setting according to some embodiments.

FIG. 18 is a flow charts showing the login process for online and offline logins according to some embodiments.

FIG. 19 is a schematic representation of the options for the ILS reporting system according to some embodiments.

FIG. 20 is an operational process flow diagram according to some embodiments.

FIG. 21 is a schematic of an exemplary computer system capable of use with the present embodiments.

FIGS. 22A-22D illustrate the hierarchical input structure of an example of the system.

FIG. 23 illustrates a portion of a source content book and a block according to the example.

FIG. 24 illustrates the processing and tagging of a block according to the example.

FIG. 25A illustrates the processing of the blocks according to the input parameters to generate an output unit in the example.

FIG. 25B illustrates an exemplary output unit of the example.

The illustrated figures are only exemplary and are not intended to assert or imply any limitation with regard to the environment, architecture, design, or process in which different embodiments may be implemented.

### DETAILED DESCRIPTION

The disclosed systems and methods address the traditionally rigid lesson structure by introducing concepts of intelligent feedback, using the appropriate set of blocks and entities, which can allow for flexibility and adaptability of an output unit to achieve certain objectives. For example, the systems and methods can break, by means of algorithms described herewith, the rigidity of an original book or any digitalized content. In traditional text books, scientific texts and management texts, that are used as references to prepare classes, there can also be very little feedback to a publisher as the teachers and students may not provide feedback on the content of the books. The implementation of relational structures of the classification of contents and its main entities according to some embodiments and the adoption of a block algorithm as described herein can break the rigidity of these texts and introduce flexibility in the process of creation of output units. This process can use several algorithms that allow the system to be able to generate metrics and feedback to the author. An annotation algorithm is also in the present systems and methods, that can allow users to store and obtain feedback on their annotations, which can be a very unique tool that includes the ability for dictation.

Even as some classes move to online classes, the traditional model is generally still maintained with students using electronic versions of textbooks matching the hardcopy versions. Further, the online learning generally only allows for viewing of lessons without the ability to modify the content or record or use feedback. The present systems and methods address this issue by providing tools to report activities, providing analytics that offers feedback data on the use, by students and/or teachers, of its output units, that can be handled (supervised, edited, or otherwise, etc.) by the author or any administrative staff, teachers, or professors involved. Handling the available data and its analytics is made possible through a special algorithm called the Information Log System (ILS) that can export information arranged in any format through a report process or algorithm.

The implementation of disruptive blended learning and the challenges with adjusting the ‘status quo’ of tools that are made available to schools illustrates a need to develop a Learning Management System (LMS) that can address and produce, in an efficient and automatic fashion, high quality materials that can reduce the time teachers and professors spend preparing classes. In response, a method of automatically developing rules to access class materials, using data analysis algorithms, is described herein that allows for the learning materials to be aimed at each individual student, or group of students in the classroom. The system also allows for a diversity of students to be pedagogically identified by certain algorithms, generating individual learning paths, even when all of the students are starting with the same or similar materials or sources that are conveniently modified in the process of obtaining the appropriate learning path introduced in the system's use of decision models or algorithms, among others possible models and algorithms. The decision model is a mechanism of evaluation of the performance of a student in a set of programs, through recognizing the student's ability and skill in dealing with concepts related to his or her answers to a set of questions about the subject that are presented, and suggesting the next set of concepts, either a revision of the previous concepts already presented to the student, or concepts that the student is already able to grasp comprising advancement of the subject matter.

In a manual system, an author (as that term is described herein) is required to manually execute searches over existing materials, whether available on the internet or those available in any physical/electronic books, and proceed to elaborate. The elaboration process can involve time consuming additional searches over materials that may not be logically organized in an integral and validated database. This can include content such as multimedia content, and depending on the source of the content, the author may also need to evaluate copyright issues related to those materials located in the search, where copyrighted materials may require licensing. Once all of the materials are identified, the resulting materials have to be transferred and stored on a computer and manually edited and composed into a lecture or class appropriate for certain period and to certain group of students. Individualized lessons may be even more time consuming when they are tailored for a specific student, attendee, or group. Once all the work is complete, the developed material is required to be transferred and stored, eventually in a computer or any LMS the author may be using, almost exclusively offering rigid, structured, and non-enriched features that are going to be shared and managed. Editing of the material prepared in that traditional format is also time consuming, inaccurate, and often used only once for a specific purpose.

The present systems and methods introduce the use of blocks (as that term is described herein), which allows the building of flexible, lively, adaptive, precise and updated class materials, automatically displayed at the appropriate generation of the class in addition to all entities that can be applied to that class. This feature allows for the flexibility in developing the appropriate material for each individual, maintaining the integrity of the original content. The system allows any content to be used, and the system is independent of the content and the level of the students and output units created. Since the system processes the content using various machine learning and artificial intelligence algorithms, the system can use content in any language to produce similar results.

As used herein, a block can allow for the building of flexible, lively, precise, updated, and adaptable class materials. As described in more detail herein, natural language processing (NLP) and artificial intelligence (AI) algorithms can provide an automatic revision process of the intended output unit starting with a plurality of blocks. In this process, the system recognizes that during the processing of the content as input into the system and the generation of a certain output unit, any additional entity or feature that has been included or excluded from the original content. The system can request confirmation from the author whether to modify the name of the output unit as previously generated, or if the system should assign a new identification for that output. These process and algorithms further allow the rigidity of traditional handling of content by LMS's to be broken, thereby allowing for the generation of the classes and content to fulfill the needs of specific attendee or set of attendees. The innovative and uniqueness of the use of blocks, which can be derived from a master block that represents in its entirety the input content transformed by the use of proprietary tools, allows the original content to be broken into smaller units based on certain parameters into a convenient set of blocks, that can be assembled, with the supervision of the author, to compose a desired and appropriate output unit.

As part of the processing of the input, an appropriate set of tag can be added with metadata, which can be used by the system to generate the output unit from the blocks. The processing steps can be supervised or unsupervised. If the system is supervised, then once supervised and/or accepted by the author, the block can be transferred and converted to a final format for the plurality of blocks. In some aspects, the blocks can automatically receive any added or suggested tags obtained from a primary tagging process or algorithm as described herewith.

In some aspects, the author can, as part of a supervised process, manually add or eliminate any tag the author thinks may better represent the content of a certain block before saving the block. The system will use, for further enhancement of the primary blocking process, the revised information. The stored information can be used as the input to the intelligent blocking process to determine the entailment of the AI model, checking its logic equivalence in an interdisciplinary model, and supervise its validity against controlled samples.

Each block is the result of the operation of the blocking algorithm from each master block. The blocking algorithm can generate one block or a plurality of blocks that will satisfy the specifications and parametrization defined by the author.

While some LMSs are available, these systems tend to all exhibit similar solutions regarding the storage and management of content. For example, any source materials are simply stored and retrieved for viewing at the selection of a teacher, school, or administrator. None of the current LMSs have any tools that allow an author to automatically access the material that will form the class materials or content, with the specificity desired to match certain didactic objectives and automatically generate an output unit. The term “output unit” is described in more detail herein. As described herein, algorithms such as master block and auto block generation algorithms can be used to create the output units using parameter specified by the author.

In order to address security and integrity issues present with traditional learning and other LMS products, the present systems and methods eliminate the use of any external software to compose its output units. For example, external software such as text editors, calendars, messaging systems, video-conferencing systems, annotation tools, software to present multimedia content, including third party software not bundled with the system can all be avoided. Rather, all of the tools, features, entities, editors, and the like are built into the system. More specifically, the systems and methods herein provide software tools capable of producing the desired format automatically and individualizing an output unit for a certain attendee or group of attendees, depending on the appropriateness and pedagogic requirement of a particular attendee, thereby enabling the design of best learning path for each particular purpose at any and every point of the learning curve.

The system and methods herein also provide automatic searching to filter and access all entities pertaining to any module being used by an author, and it is presented in such a fashion that the author can readily point to those that will finally compose the desired output unit. The searching can use both text and phonetic searching along with ranking the results by relevance using the methods as described herein. This ability provides the fine-tuning tool with minimum human intervention to modify, enhance, and deploy the output unit that resulted from the automatic block generation.

The present systems and methods relate to the application of computer science and the implementation of intelligent algorithms and models to increase the efficiency and automation of the preparation of materials for teaching, lecturing, and learning by an audience of specific attendees. The Automatic Generation of Lectures Derived from Generic, Educational or Scientific Contents, Fitting Specified Syllabus (“AGLFS”) system comprises engine for the automated production of finished materials to enable teachers, professors, lecturers, or any other speaking purpose, presenting classes, lectures, speeches, presentations, etc. based on source materials such as academic books and textbooks, scientific papers, or any other material combined appropriately and distributed through all Entities of the system such as questions, answers, exercises, activities, videos, audios, etc. that will compose the desired presentation.

In some aspects, the AGLFS system can automatically generate materials to encompass appropriate classes, lectures, presentations, etc. by processing any contents regardless of its nature to produce the output unit. The output unit depends on the parameters specified by an author and on the format and pattern characteristics of the content. By using certain content in any digital format, the system's eRoot's algorithms can recognize the parameters specified by the author, and applies them appropriately, by filtering and organizing data to generate blocks through the master block algorithm combined with other entities, to be assembled and constitute the desired output unit. In some aspects, the system described herein can be referred to as the eRoot or r4 as shorthand, and the source materials as described in more detail herein can be referred to as the adRoot or r4Content herein.

Algorithms or models can be appropriately stored in the memory and executed to create one or more output units. The algorithms or models can include modeling (e.g., including AI or machine learning (ML) models, etc.) and/or NLP. Those algorithms that are used to generate, through suitable machine learning tools, can include semantic models used to access the content in its various formats, generate relationships among several output units and its entities or elements such as questions and modules, exercises and modules, etc., using the entailment algorithm, annotating and tagging algorithms to be applied in each block, etc.

The present systems and methods have a number of innovations including the use of NLP to allow interaction between the attendee/author with the system by voice. The uniqueness of access by voice, in a LMS, to the output units, glossary, math formulas, chemistry equations, videos, supported also by entailment and searching algorithms all working together and can be built into the system, and the like are important innovation in LMS systems. The voice algorithm, described herewith, is a unique feature of the AGLFS that can allow the attendees and students to interact and communicate to access and/or store information in the database.

The implementation of the use of blocks, which includes dividing the content having a variety of formats and allowing its use by algorithms to create output units, as desired by the author is described in more detail herein. The system allows the arrangement of the resulting blocks, displaying all applicable tags, that were automatically annotated by the system, using those tags, along with the input parameters, to choose appropriate entities to generate one, or as many as desired output units.

In some aspects, the AGLFS system aims to provide tools and applications, based on an intelligent and logical structure, capable of automatically recognizing and organizing, in a pedagogical manner, a pre-specified or pre-defined syllabus and objectives, all logic parts of certain contents that are stored in the database repository of source materials and content. The materials can be selected and used to generate one or more elements forming a lecture (e.g., blocks, etc.), to fit any kind of presentation, classes or lectures, composing, organizing, and structuring through algorithms disclosed herein, all applicable entities such as texts, exercises, multimedia, questions, key concepts, key terms, pre-requisites, and advanced placements to generating an output unit. The output unit can satisfy any pre-defined purpose expressed through certain parametrization defined by the author.

Various terms are used to describe the systems and methods herein. The terms will first be described and then the systems and methods will be described with respect to the processing and transformation of the content in the output units using the system. As used herein, an attendee is a person or a group of persons receiving access to an output unit.

An author can be any person or persons that generates the input or parameters as inputs to the system, and which the system uses to generate the output unit(s). For example, the author can be the person who is granted access to a table of parametric strings in which all of the conditional parameters such as pedagogic objectives, depth and details of contents, entities to be used as support of the lecture, etc. can be established to automatically generate the output unit of a certain required lecture. Various input formats for the parameters can be used, and the author is not limited to any a particular role in the education or content generation process.

Complementary activities can include those activities that can be performed as the pedagogic result of a certain output unit. The complementary activities can take advantage of information described and expressed by the report system, thereby allowing the author to enable and complements the suitable output unit for each attendee or set of attendees, in any way or form emphasizing concepts, techniques, knowledge acquisition, etc., through group interaction, normally executed at premises. In some aspects, complementary activities can include, but are not limited to activities such as workshops, group studies, individual studies, and/or projects.

The content (which can be referred to herein as the adRoot and/or the r4Content) is the set of source information analyzed by the system to form the master blocks. The r4Content can have any format such as documents, books, papers, and any text, multimedia files, and the like. The r4Content serves as the source content for the blocks derived from the master blocks, where the blocks are used to form the output unit.

As used herein, the term academic discipline refers to the function or process through which the author defines and the system stores the highest level of the hierarchic tree.

An entity is a logical object consisting of a set of information (e.g., data, properties, etc.), which can be defined based on its functionality, encompassing the same classes of concepts, properties, structure and unique characteristics grouped for logical and functional access by the system's algorithms and/or models.

The systems models can be referred to as the eRoot or r4 herein, and the system includes the set of algorithms, AI engines, software programs, logical structure, front-end, entities, parametric classes, database structure, and redundancy schemes used with the present systems and methods.

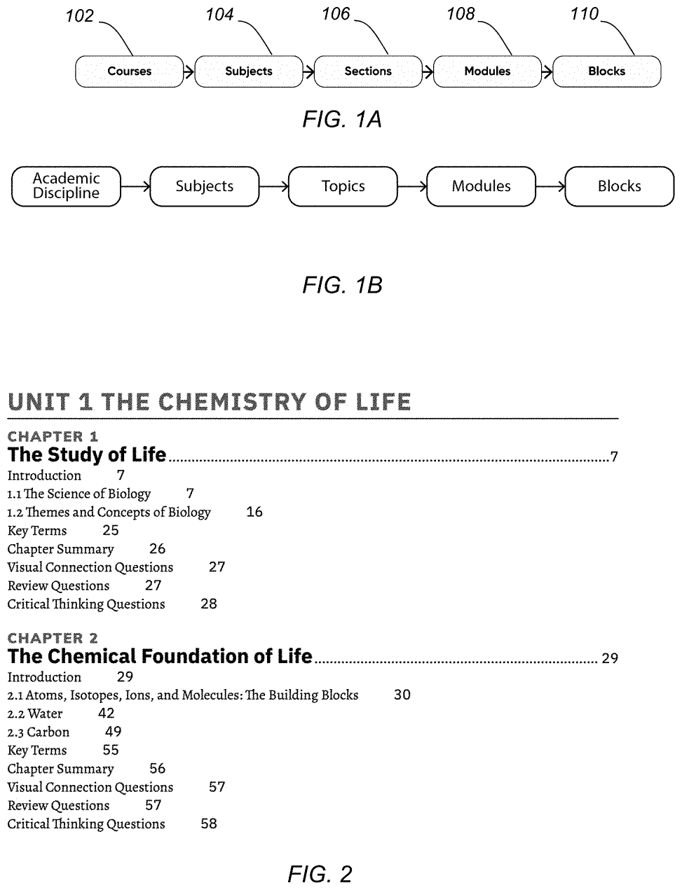

A hierarchical tree is the structure used to define the taxonomy and organization of content derived and processed from the source content or r4Content. In some aspects, the hierarchical tree can include the academic discipline, then subjects, then topics, then modules, and then blocks. The definition of the structure can have multiple elements at each level in a branching or tree structure. For example, the academic discipline can have a plurality of subjects, each subject can have one or more topics, each topic can have one or more modules, and each module can comprise one or more blocks. Exemplary hierarchical trees are shown in FIGS. 1A and 1B.

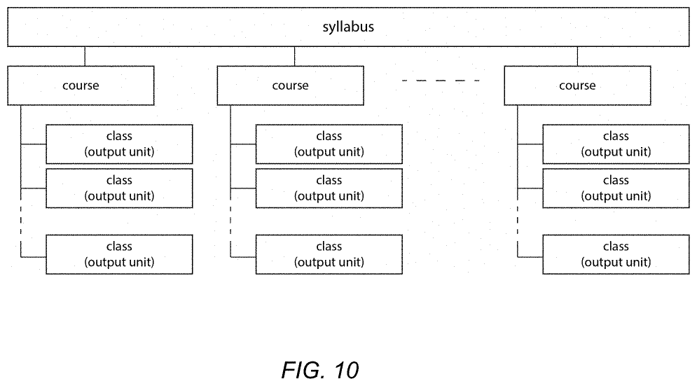

An academic tree refers to the structure used to define the taxonomy and organization of the class structure. In some aspects, the academic tree can be defined by a syllabus, courses, and classes (e.g., as shown in FIG. 10). The classes can be formed by the output units as described herein. The definition of the structure can have multiple elements at each level in a branching or tree structure. For example, an academic discipline can have a plurality of courses, and each course can comprise one or more classes or output units. In some aspects, additional levels can be formed within the academic tree as part of the output units.

A lecture is an entity that composes or forms a part of an output unit of the system.

Modules are a function through which the author defines, names, and describes properties pertaining to all matters included in each section. The author can define the properties through the modules with the system forming the modules themselves. Alternatively, the author can define the specific items in each model. As an example, an author can define the parameters within the modules by identifying the subject matter of each session. As an example, the author could define a first module as “The Science of Biology”, a second module as “Themes and Concepts of Biology”, and a third module as “Atoms, Isotopes, Ions, Molecules.”

Sections are a function through which the author defines, names, and describes properties about all matters included in each subject.

Subjects are a function through which the author defines, names, and describes properties pertained to all matters included in a course.

Questions are a series of requests to the students or attendees that can generate feedback for use in the system. The questions can be generated by the algorithms and models or input by an author. The questions can be grouped in any convenient format, and be automatically evaluated by the system to generate reports for authors. Once automatically evaluated by the systems, the results can be submitted to the decision algorithm. The decision algorithm can generate inputs to the teacher, for validation, and to the attendee, trigger the creation of one or more new output units and/or any other entity (like a new series of questions; a group of exercises; another class, either advanced or of revision type), thereby adjusting the learning path for each attendee or group of attendees. For example, the system may generate output units such as classes for beginners, intermediate, and advanced students.

Exercises include a set of offered activities to be executed in written format, in which the evaluation of the pedagogic results are not treated by the system but rather by the teacher.

Evaluation entity is a special class of output units where the author offers for evaluation not only questions, but exercises, essays, etc., which are evaluated by the author, not by the system, in the process of grading.

Mathematical formulas and chemical equations can be represented as a specific format within the system due to the specificity of such equations and formulas. The AGFLS can implement special entities such as chemical equations that can include concepts, atomic structures, and the like. The same entity allows the use of 2D and 3D images, with the interactive algorithms solely dependent on the content used by the Author. For example, in the process of forming the master blocks from the r4Content, chemical equations and/or mathematical formulas can be extracted and handled as unique entities that can then be tagged and used with the associated text. In some aspects, the system can be configured to recognize and extract certain information as non-text entities, even if such entities contain text, within the source materials and extract the information as a non-text entity with the appropriate tagging to associate the non-text entity with the surrounding text in the master block.

The master block is an entity derived from the r4Content (e.g., the input or source content) as a result of the automatic division of the text and other information and fitting certain parameters that identifies properties in the content format. The generation of the master blocks allows for the automatic generation of a block that comes from the master block algorithm, which processes the content or master blocks being formed into blocks. In some aspects, the master block algorithm or model accepts the source content as input and serves as a data extraction algorithm or model where the resulting output model is the master block.

A block is the output of the blocking algorithm using each master block as an input. A block is the smallest logic unit handled by the system and algorithms pertaining to a logic tree that includes the atomic content which maintains the integrity of the meaning of a certain concept, idea, principle, or explanation, and that can pedagogically be concatenated to another block, or blocks, using some semantic, syntactic, and time constraint algorithms to guarantee the integrity of those attributes (concept, idea, etc.) exposed within that block.

An output unit is the result of the application of the system and methods representing the material parametrized by the author, to be used by any speaker, teacher, professor, keynoter, or any person for whom the presentation has been prepared. An output unit can be accessed by an attendee through one or more output devices such as a mobile phone device, tablet, computer, or any device with access to a data network such as the internet. As an example, an output unit can comprise one or more blocks and/or associated entities selected and arranged based on the parameters selected by the author by the algorithms and models described herein.

Having described the definitions, the system and a corresponding operation of the system can now be described. For purposes of describing the system and how the system operates, an exemplary book on biology is used as an example. While the examples show content related to a specific subject, the system and methods described herein can be used for any content as the systems and methods are content neutral. Rather, the systems and methods disclosed herein are used to identify logical units, form available blocks, and construct lessons and output units automatically.

The system can comprise a number of units and models configured to use source content having a variety of types and formats for information and convert the source content into custom output units using parameters specified by an author. The system can be configured to accept various parameter inputs and use those along with the available content to assemble or generate one or more output units. The system can be configured to generate an output unit using a logic tree that can accept or access available content and entities. Using the author's inputs along with the content, one or more blocks can be generated by the system. The resulting output units can be parameterized. The result of the system can be the generation of one or more output units. The models and algorithms associated with these steps can now be described in more detail.

The system allows for parameters (specifications) to be provided. The parameters can be used and applied to the generation of blocks, as described below, from each and every master block generated by the content. In addition, the source content (e.g., r4Content) can be loaded or input into the system. In addition to the parameters, the hierarchical tree can be input as part of the system. The hierarchical tree can be added as part of the parameterization by the author. An exemplary hierarchical tree is shown in FIGS. 1A and 1B. The parameters and content can then be used to generate blocks and tags. The first step in generating blocks is the generation of master blocks for each topic. Each master block can be identified using the hierarchical definition as input by the author. Information in the input content such as the content listing or outline can be used as part of the master block identification. As an example, the table of contents can be processed as the master block identification from a book. As shown in FIG. 2, the subject matter listing can be used to identify the initial master blocks. The system can automatically parse the relevant information into the master blocks and then provide the master blocks for review and inputting of additional information by the author.

As part of the master block generation, the hierarchy tree can be completed. For the example shown in FIG. 2, the hierarchy can initial define the academic discipline, the subjects, and the topics to identify each master block. For example, the academic discipline can be input as “biology”, the subject can be input as “the chemistry of life,” and the topic can be input as “the study of life.” Other information can also be associated with the master block when it is generated. Once the master blocks are created and saved, a master algorithm can be used to construct individual blocks from the master blocks.

The master block generation algorithm can accept as input the content and the hierarchical tree or the hierarchical tree information. The master block generation algorithm can then extract the content within the master block using the logical analysis of the content and associate the hierarchical tree with the corresponding master block. This process can divide the content input into the system into one or more master blocks with associated hierarchical tree information for use as an input into a master algorithm for generating individual blocks.

The master blocks can then be passed as input to a blocking algorithm, which can also accept the parameters input by the author in the initial input stage. The parameters can be input or selected to create a parameterization set or file that can define various parameters requested by the author. The parameter can serve as constraints on the selection and formation of the blocks from the master blocks. The blocking algorithm can then process the master blocks to generate information for one or more blocks by applying the parameters to the master blocks. The blocking algorithm can be a simple algorithm or a model used to produce one or more blocks logically adhering to the input parameters. By evaluating the result obtained in the construction process of a block from the blocking algorithm, the system is able to verify the logic unit's adherence to the parameters of the constraints function.

Once created as the output of the blocking algorithm, the blocks can be presented to the author for review, and the blocks can be certified, by the author, as a block to be saved. If the author needs changes, the author can either directly change the block, or the parameters can be updated and the block can be reprocessed. Upon certification of the block by the author, the system can automatically recognize and filters any pedagogic entity (questions, activities, exercises, etc.) and multimedia entity related to a specific block and offers those related entities to be picked up by the author in the process of generating the output unit. As described herein, the related entities can be extracted from the master blocks themselves or separately created. As an example, any images within the master block can be extracted as a separate entity and associated with the block. Any questions, activities, formulas, or exercises within the master block can be recognized using various processing techniques (e.g., NLP, etc.) and separately extracted as the corresponding entities associated with the block.

As an example, from the biology book, the system may process a PDF version of the book to identify the table of contents and automatically extract a chapter on a specific topic as a master block. Within the master block, images may be present as well as formulas and concluding questions for the students. When the master block is processed by the blocking algorithm, the images, formulas, and concluding questions may be extracted as separate entities. The remaining text may be processed using the parameters by the blocking algorithm to generate a block having the desired properties, and the images, formulas, and concluding questions may be associated with the resulting block in a way that allows the author to include one or more of the associated entities if selected.

The blocking algorithm generates as an output one or more blocks that comply with parameters provided by the author. Examples of the parameters include the duration of a block. The duration of the block can include the time needed by a student or attendee in covering all items included in that Block. The duration of a block can be determined by the system using parameters that include the number of words per minutes applied for that block, and time spent on associated entities included with the block such as time spent on figures, time spent on images, time spent on tables; time spent on activities, time spent on examples, and/or time spent on media. If the duration of a block exceeds the duration specified by the Author, the blocking algorithm can slice the block into 2 or more parts, each one with the approximate duration specified. The sliced blocks can be presented to an author for adjustment. For example, an author can visually inspection the blocks generated by the system, adjusting the duration and the slicing points of one or more of the blocks.

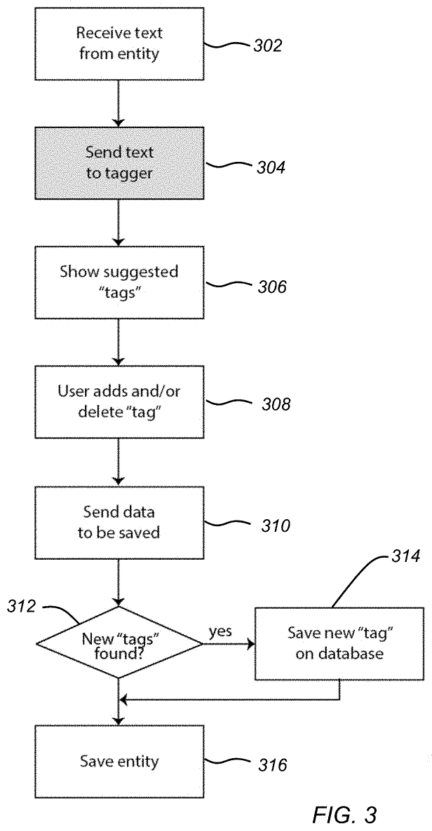

Once the blocks are created, the blocks can be tagged to aid in the formation of the output units. Several tagging processes are possible to generate useful and valid tags. For example, when the blocks are complete and are saved, the blocks can enter into the tagging algorithm(s). A tagging process is illustrated in FIG. 3. As shown, each entity created by a master block algorithm or blocking algorithm can be processed to identify text at step 302. For various processing techniques such as character recognition can be used to identify any text present if the text is not already in a text format. At step 304, the text can be sent to the tagging algorithm or model and processed. The processing can result in the extraction of one or more text strings to use as tags for the block and text in the block. The automatic extraction of the text strings as tags can then be suggested to the author at step 306. The author can select or modify the tags at step 308 to generate one or more tags that can form a tag set for the entity being analyzed. Once the appropriate tag set is selected, the tag set can be saved in step 310. The saved tags can be associated with the entity, for example as metadata associated with the entity.

In looking at the tags created for an entity, the tag set can be stored in a tag database used to identify tags across all processed entities. In step 312, the one or more tags in the tag set can be compared to existing tags in the tag database. If new tags are identified that are not already present in the tag database, then the new tags can be added to the tag database in step 314. In the event that no new tags are identified or after the new tags are saved, the tags associated with the entity can then be stored as part of the entity storage in step 316.

In some aspects, a primary tagger model and an entailment tagger model, which in some aspects can work together, can be used to generate an intelligent process for automatically tagging the blocks, using NLP and certain statistical algorithms and models. The primary tagger can identify, in or from the content, tags that can comprise certain data, metadata, and/or file identifiers. In some aspects, the primary tagger can operate to automatically generate the tags when the block is loaded or saved in the memory as a result of the master block tuning by the author. In some aspects, the system can implement a mathematical algorithm, attributing weights to certain tags, depending on the statistical relevance of the tags, number of words in a tag, and/or number of entities for which the tag is validated, thereby allowing the establishment of certain logical entailment and correlations between entities and/or output units and helping the author in establishing practical applications of each subjects been presented. The database of tags can increase the number of tags over time as the system receives additional diverse tags and a greater quantity of tags. The tag database can be used by each tagger and tagging algorithm such as primary tagger and the entailment tagger. This may provide additional data to train the algorithms and models to allow for a much larger number of useful and accurate tags and entailments over time.

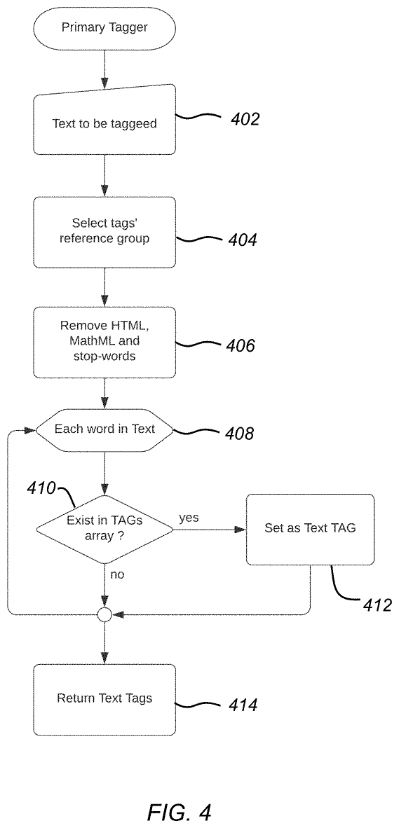

In use, the primary tagger can create tags using the process as shown in FIG. 4. At step 402, the primary tagger can receive the text to be analyzed. In some aspects, the text can be received or extracted from the block using any of the processes described herein. The primary tagger can then select, through the module to which it belongs, a group of tags that will be used as a reference at step 404. The reference group can comprise a list of tags that are common to the module, or are selected based on the module. The text can then be pre-processed at step 406 by removing formatting (e.g., HTML), encoding, stop-words and non-text elements. In some aspects, the text can be processes to provide a uniform formatting such as removing capitalizations, and other formatting. At step 408, each word or word groupings can be parsed and send to the verification process in step 410. In the verification process, each word or word grouping can be compared to the tags in the list of tags. If the word or word grouping matches any of the tags in the list of tags, then the tag can be selected as a tag for the entity in step 412. If the word or grouping of words is not present in the list of tags, then the process can continue on to the next word or group of words until all of the words have been compared to the tags in the list of tags. When all of the words or group of words have been compared, the tags that are identified can be marked as tags for the entity in step 414 and associated with the entity.

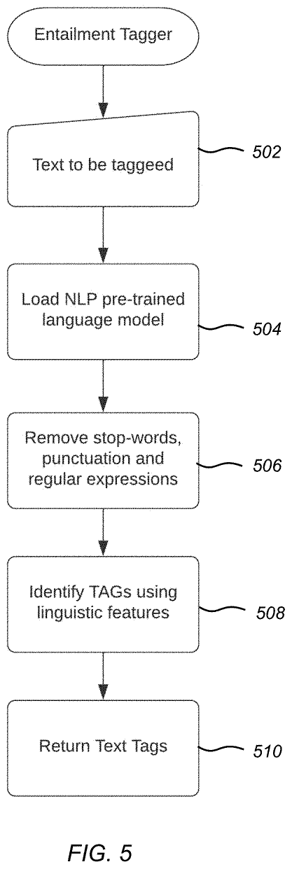

In some aspects, the tagging process can also use an entailment tagger, alone or in combination with the primary tagger. The entailment tagger is a process that returns a set of tags as a text list. A process performed by the entailment tagger is shown in FIG. 5. As shown, the entailment tagger initially loads or extracts the text from one or more blocks to be processed in step 502. The entailment tagger can use various algorithms or models to perform the tagging operation. For example, various machine learning models such as NLP pre-trained models can be used as part of the entailment processing process. At step 504, the relevant models can be loaded for use in the system. At step 506, the text being analyzed can be pre-processed to remove any formatting commands, standardize the text in lowercase characters, and remove stop-words and punctuation. The pre-processing step can also be considered a standardization step to allow the text to be input into the processing models.

After the pre-processing, artificial intelligence algorithms load a model-based and trained in NLP using the pre-processed text as an input at step 508. The models can return the document's tag set as the output at step 510. The models can serve to extract specific words or word groupings to serve as tags. In some aspects, the models can also convert words or word groups to other words or word groups to account for linguistic differences or styles between different source materials. In this sense, the entailment tagger serves to harmonize the tags between different sources or even between different modules to produce a consistent set of tags for use in producing the output units.

In some aspects, the primary tagger and the entailment tagger work in combination. The entailment tagger allows different terms and tags to be identified from the text in the blocks and entities. This allows the list of tags used by the primary tagger to be updated. The list of tags can also be annotated by a user to help identify common tags and improve the NLP models used by the entailment tagger. The training module of the entailment tagger can update the model and test its accuracy by generating a set of tags for a sample of text. Once these tags are generated, it compares them with the tags annotated for the texts used and calculates their accuracy. As more text is added and processed by the algorithm, that is, as more text becomes part of the system, the result can improve over time. The results can then be used by primary tagger in the tagging process. The iterative nature of the training and use of the primary and entailment algorithms in combination can then improve the automatic tagging process across blocks and source materials over time.

Once the blocks and entities are processed and tagged, an entailment algorithm can be used to establish relevant relationships between the blocks. The relationship between the entities, based for example on the content of the entities as provided by the tags, can be evaluated by the system by semantically evaluating the tags that the entities have using the entailment algorithm. A relationship between the entities can be based on the number of tags in common, the specificity of the tags, and/or the number of compound tags (e.g., those with two or more words), and the algorithm can determine the relative relationship between the entities using one or more of these parameters. In general, the more tags in common, the more specific the tags, and the greater the number of compound tags (two or more words) that exist between two entities, the more related these entities would be considered. In some aspects, some entities may be marked as being associated with another entity. For example, an image or formula that is stored as a separate entity (e.g., an image) may be marked as being associated with the block from which the image or formula is extracted.

In looking at the relatedness of the entities, the algorithm or model can compare the semantics of the content of the entity by evaluating how statistically significant each tag is or by searching expressions within each entity. For example, to find the relations of an entity “A” with other entities, the algorithm can compare each tag of an entity “A” with the tags of the entity set. A value of zero can be assigned when the tag is not found and a value that varies with the specificity and type of each matching tag can be assigned when the tag is found. Adding the values determined for each tag, the element of the set can be assigned a score and, the higher this score, the greater the probability of a relationship between the entities. Tag specificity is measured through its frequency in the total set of entities. The lower the frequency, the higher the specificity of the tag. The type of tag can be summarized as simple or compound (e.g., having two or more words), and as part of the determination, the words that make up the tag are counted after removing the stop-words.

The present system and methods implement specifics algorithms using NLP, statistical learning algorithms and models including supervised and unsupervised learning models to establish searching processes to relate texts and contexts among all entities, allowing a constant statistical learning through the models, improving efficiency, and augmenting accuracy by the automatic filtering process. The filter receives the text that has been tagged and the tags generated from the text, calculates the probability that each of the generated tags is an appropriate tag, uses a classifier of these tags based on the semantic context, and checks the frequency of occurrence of the tag in a group of entities. The process can update as additional text and tags are generated by the system.

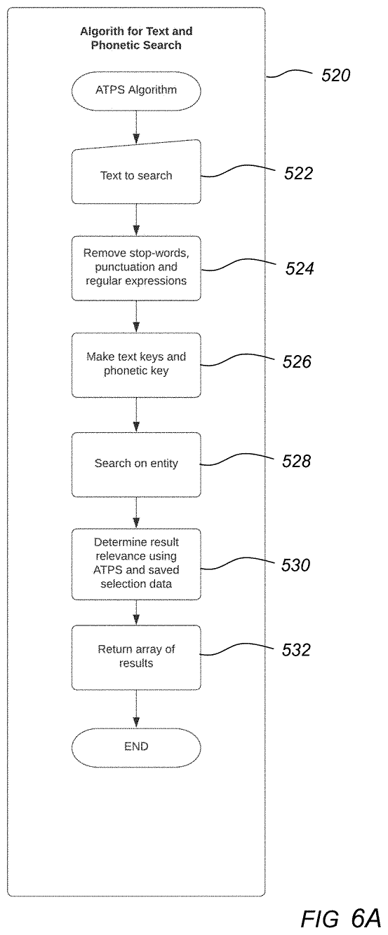

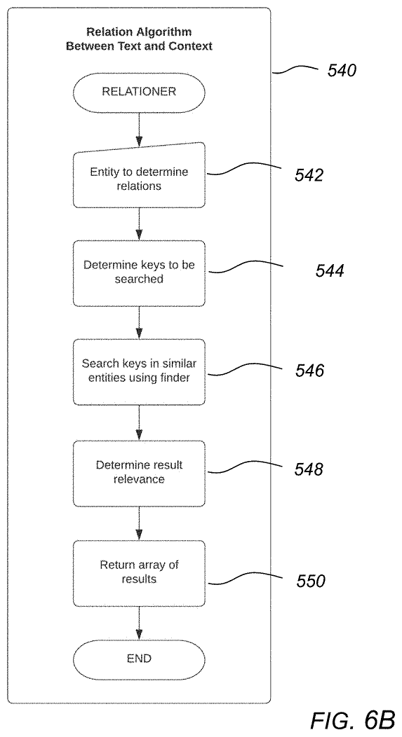

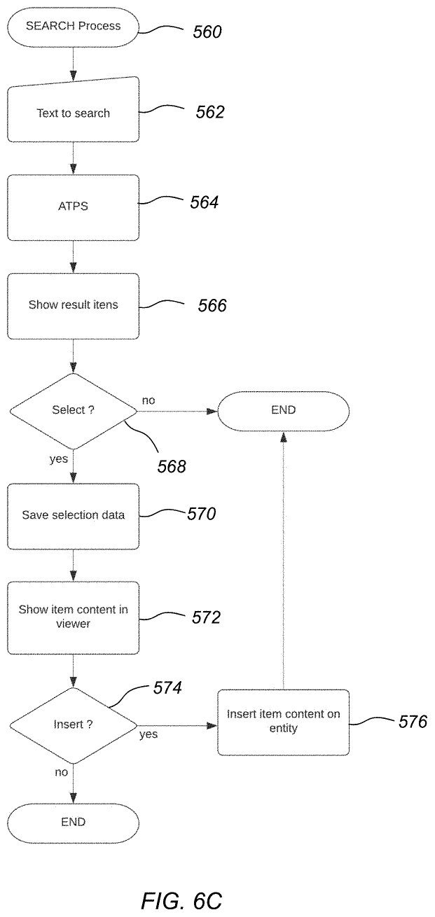

An algorithm for text and phonetic searching is shown in FIG. 6A. As shown the algorithm 520 can start with receiving the text to be searched at step 522. Any stop-words, punctuation, or common or regular expressions can be removed at step 524 to identify the remaining text as the search terms. The remaining text can then be converted to text keys and phonetic keys at step 526. The text keys can comprise text words or phrases used for searching purposes. Phonetic keys can represent search terms that have similar phonetics even if the spelling is different. This can help to allow for broader searching where the exact words may not be known as well as using a speech interface for searching purposes. At step 528, the entity or entities can be searched using the text keys and/or phonetic keys from step 526. Any matching words in the entity or entities can be identified, and the relevance of the results can be determined at step 530. The relevance can be determined using the process described herein for the number of matching terms, the relative occurrence of those terms, and the like, taking into account both the text keys and/or the phonetic keys. The array of results can be returned at step 532. In some aspects, the results can be returned based on the relevance of the results.

A similar process 540 is shown in FIG. 6B for determining a relative relationship between the text being searched and the context of an entity. At step 542, an entity can be selected for the determination of a relationships. In some aspects, the system can review entities over time so that the relationships between entities are tracked. In some aspects, the process 540 may be performed when an entity is created or used to identify related entities at the time of creation or use. In some aspects, an author or student may select an entity for searching so that the process 540 can be triggered by the search. Once selected, the keys to be searched can be determined at step 544. The keys can be determined in the same or a similar manner to the determination of the keys in the process 520 with respect to FIG. 6A. The keys can be determined as part of the process 540 and/or the keys can be determined and stored with the entity (e.g., as part of the process 520 or a similar process). When the keys are stored with the entity, the keys to be searched at step 544 can be retrieved from the entity. In some aspects, the keys determined at step 544 can be stored as part of the entity for use in the future.

At step 546, the process 540 can use the keys for the entity being searched as the basis of a search in other entities. The search process can be the same or similar to the search process in the process 520 of FIG. 6A. For example, the keys to be searched can be compared to keys in other entities to identify a results list. In step 548, the relevance of the results can be determined. For example, similar keys can be identified and scored using the relatedness of the keys and other factors (e.g., simple or complex keys, relative frequency of the keys, etc.). The determination of the relevance may be the same or similar to the process 520. At step 550, the results can be returned or stored within the system. In some embodiments, the results can be ranked by relevance and returned. A threshold may be used to identify the results having a score above the threshold to identify the desired level of relevance.

An overall search process 560 is shown in FIG. 6C. At step 562, the text to be searched can be obtained. The text to be searched can be obtained in a manner that is the same or similar to the process 520. In some aspects, the text to be searched can be processed similar to the steps in process 520 as described with respect to FIG. 6A. At step 564, the process 520 can be performed using the text to be searched. The process 520 as performed at step 564 can result in a list or array of results being returned. The results can optionally be shown, output, and/or displayed at step 566. For example, an author or student can view the results to allow for a selection of the results to be made. The results can be ranked or ordered based on relevance in some aspects. At step 568, one or more of the results can be selected. If no results are selected, then the process 560 can end. If one or more results are selected, then the selection of the result can be saved at step 570. As an example, the selection of the one or more results can serve as an indication that the results are related. In some aspects, the relevance scores and selection data can be saved to indicate that the entities are related based on the selection of the one or more results. At step 572, the selected one or more results can be shown or displayed. The viewer can then decide if the one or more selections should be used with or inserted into the entity at step 574. For example, an author developing an output unit may search on related entities and select one or more entities to be inserted along with an initial entity as part of an output unit. If the entity being viewed is not selected to be used with the initial entity, then the process 560 can end. If the entity is selected for insertion into an output unit, then the process can proceed to step 576, where the content can be inserted into the entity and/or become part of an output unit. The process can continue to allow a viewer such as an author to continue to view the results and insert one or more entities from the results. Once all of the results have been viewed or not selected, then the search process can end.

The organization of the data once created can form a hierarchical relationship. Examples of such relationships are shown in FIGS. 1A and 1B. Once another master blocks block is identified from the content, one or more blocks 110 can be assembled to compose or form one or more output units 108; a set of modules 108 can be identified as pertaining hierarchically to a section 106; a set of sections 106 can be identified as encompassing a subject 104; and a set of subjects 104 can be identified as encompassing one or more courses 102. Together, the set of functions forming the flow shown in FIG. 1B can be referred to as hierarchical classification of the entities.

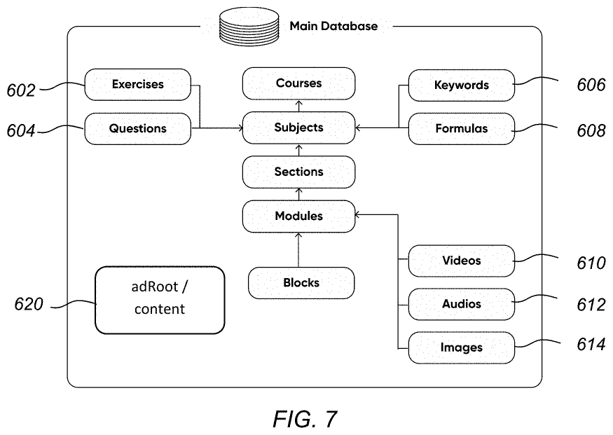

Additional elements within the system are shown in FIG. 7. The additional entities can be stored in a memory such as a database. In addition to the blocks, 110, modules 108, sections 106, subjects 104, and courses 102, additional entities can include exercises 602 and questions 604, keywords 606, mathematical formulas, and/or chemistry equations 608. The exercises 602 and questions 604 can be created to form testing for feedback purposes as part of an output unit.

The glossary 606 (as described in more detail herein), mathematical formulas, chemical equations, and multimedia 608 can all be included based on the defined parameters to provide a specified level of detail in the final output unit. Within the database, the exercises 602, questions, 604, glossary 606, and formulas 608 can be stored as data along with parameters or identifiers corresponding to parametric inputs defined by the author to allow the system to automatically incorporate the appropriate materials to form an output unit. As shown in FIG. 7, the content 620 can also be loaded into the database and used as part of the output unit generation process as described in more detail herein.

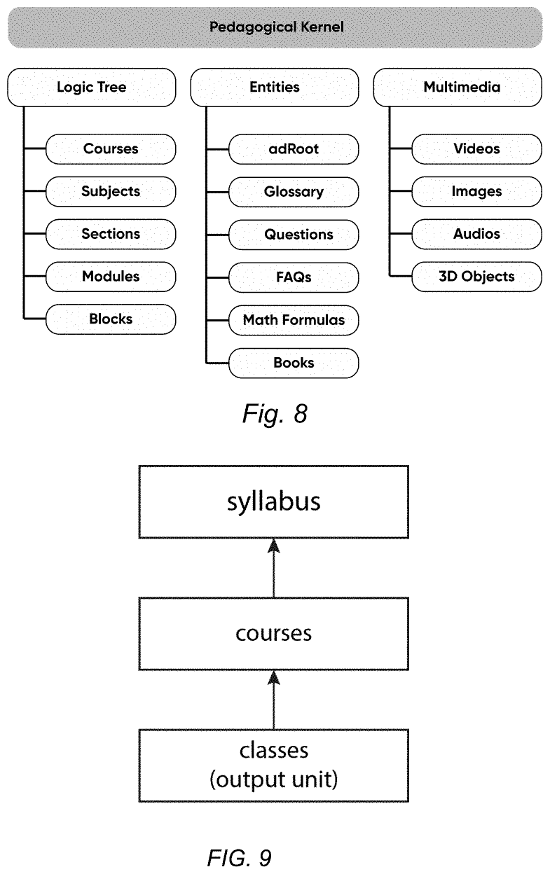

In addition to this hierarchical classification FIG. 8, the eRoot can assemble one or more convenient output units taking advantage of all entities and also following certain system parameters that reflect the desired degree of complexity by the author, depending on the type of attendee to which they are aimed to be applied. Any suitable education level such as elementary school, middle school, high-school, undergrad or graduate courses including, in addition, those aiming as extension, generic presentations, and/or training courses. While certain pre-defined education levels can be used, any set of content and education materials (books, papers, text documents, etc.) associated with certain formats in conjunction with parameters, can be used as inputs to the eRoot to create a custom target education level, including those outside of the education environment. In such a case, the system provides a version identified as independent courses, with a specific hierarchical tree.

All entities, regardless of the version, are designed to present the flexibility to be accessible, by any kind of author, to accommodate the specificity of the required output unit. As shown, the pedagogic kernel houses entities and functions that are responsible for structuring all content to be used by the author in the organization of output units. As described above, the logic tree comprises a set of functions that define the hierarchical structure of the information composed by the system. Through the built-in logic tree, the author has full access to any content or part of a content, applying the functionality of the blocking algorithm, to any specific part of interest in the content or entity, that the author understands can be used to be treated by the algorithms of the system in the process of building the suitable output unit required for a certain attendee or group of attendees.

The output units produced and/or stored in the system can be organized in sets so that they are displayed to the student in an organized and easy to understand and locate manner, in another didactic tree format where a set of one or more classes (e.g., output unit(s)), that are organized to form a course. A set of courses can define a syllabus.

For this, they are gathered in an entity called a course that encompass several classes. A course is therefore, a set that gathers one or more output units that deal with a certain academic discipline. A course can contain only one or as many classes as are necessary to appropriately cover the content of the academic discipline as depicted in the academic tree in question. The courses, in turn, are gathered in another entity, called a syllabus. The syllabus is, simply put, the list of courses that the student must complete in order to conclude the proposed teaching grade. It is important to realize that, depending on the type of institution, the syllabus will contain courses from various academic disciplines.

This organizational structure of the classes can be represented as shown in FIGS. 9 and 10. This organization of courses, associated with the system's ability to export the content of an output unit in several formats, allows the system to produce documents and e-books with any content, ranging from of a single output unit content to a complete course (all output units related to that course). The system allows for the export of a data comprising an academic discipline (all courses belonging to that academic discipline) forming a complete grid (all disciplines, all topics, all output units) to compose a collection of academic books in the specific format designed to fulfill the requirements of any pedagogic specification of any educational institution.

Once the author is in the process of producing an output unit, the system can provide an extensive set of entities and parameters, that can be used as inputs to improve, optimize, and/or appropriately construct an output unit such as a lecture aimed at an attendee or set of attendees reflecting the degree of complexity and the extension of advancement of the output unit.

The system and methods described herein can be used to generate one or more type of output units. Several classes of output units can be created to accomplish the desired educational or skill development objectives. For example, an output unit can comprise a lecture used for teaching purposes. Additional output unit classifications and elements are described in more detail herein.

The resulting output units can then be used and presented to an attendee or group of attendees. Feedback can be obtained and used as an input to the algorithms to further refine the output unit, as described in more detail herein.

Each element of the logic tree can be or define a function through which the author defines, naming, and describing properties pertaining to all matters that are to be included in each entity above the current entity. The system allows for the function to be defined as an input from the author. Once the inputs are defined, the algorithms can use the inputs in the models to classify the outcome defining the next entity. For example, when extracting a block related to physics, a classification could include: Physics->Mechanics->Kinematics->Free Fall->Torriceli's Equation (Academic Discipline->Subject->Topics->Module->Block)

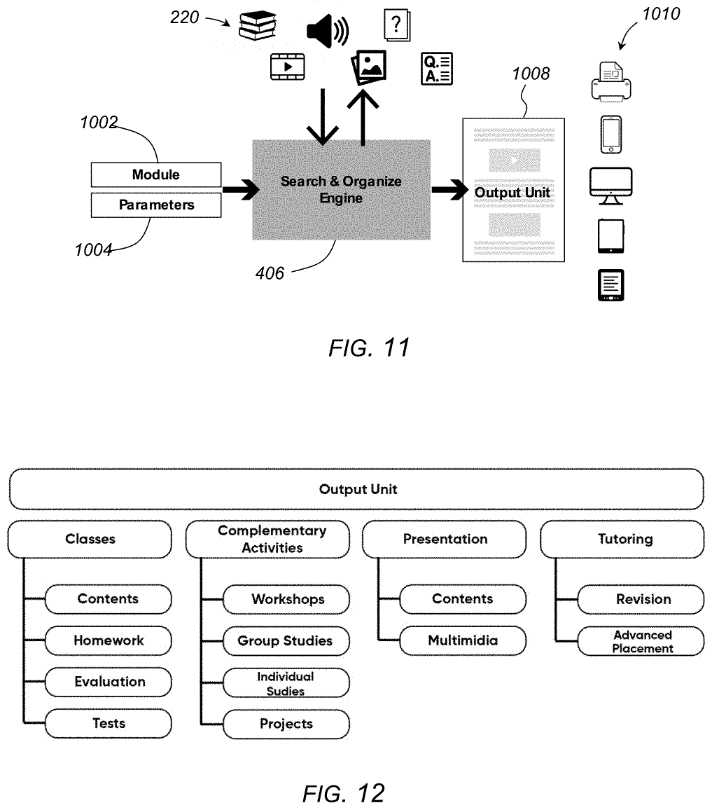

As shown in FIG. 11, the various modules 1002 (e.g., the elements of the logic tree) along with the parameters 1004 defined as inputs by the author can be used as inputs to one or more algorithms 1006. The algorithms can access the content 220 and produce an output comprising one or more output units 1008. The output units 1008 can be provided to an attendee in various forms including through various output devices 1010. In the system shown in FIG. 11, the modules 1002 can include any of those described herein, and the parameters can be those used in the functions defined by the modules 1002 that define the desired output module 1008. As described in more detail herein, tags associated with the blocks can be used as part of the process in forming the output module 1008.

Based on the execution of the models, the system can generate one or more output units. The output units can be generated in accordance with the parametrization used by any author to intelligently execute algorithms to optimize the output unit. FIG. 12 illustrates examples of suitable output units or components of the output units that can apply to an education setting. As shown, the output units can include classes comprising specific content such as one or more lectures along with corresponding homework, evaluation(s), and tests. The output units can also comprise complementary activities such as workshops, group studies, individual studies, and projects. Presentations can include elements similar to lectures, content, and multimedia useful as part of the output unit. Additional tutoring materials such as revisions and advanced placement materials can also be generated for use by the author if desired. While described in terms of the educational environment, other output unit elements can be created for other environments such as training environments, speeches, and workplace materials.

The generation of the output units can rely on the blocks and corresponding tags to search for entities that correspond to the input parameters (e.g., the parametric strings provided by the author). The results can then be filtered, organized in a logical format, and formatted to form a cohesive result fitting automatically to the syllabus with the specificity for each particular attendee.

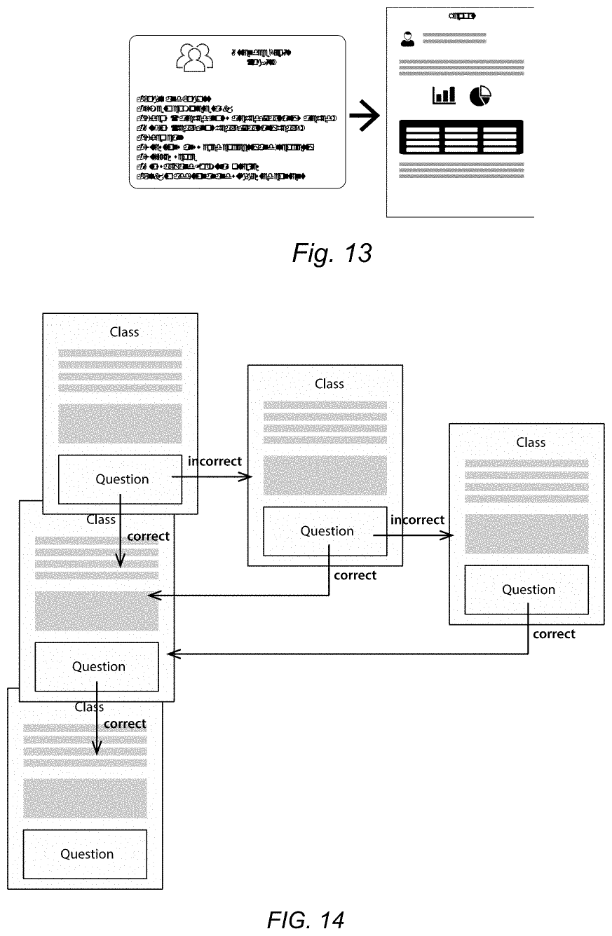

Once the output units are created, the output units can be presented to a student. When the output unit is presented to an attendee, the system can collect feedback in the form of information about the attendee and send that information back to the system for storage and processing. FIG. 13 illustrates the feedback received on the output device that can be converted to information on the attendee interacting with the output device. In some aspects, the system can collect a large amount of information about attendee behavior and learning characteristics, processing it, using artificial intelligence algorithms, in order to present it not only to the attendee's tutor, but automatically suggesting to the attendee what actions can be taken to maximize his performance. Feedback can include various types of information such as how many and which answers to questions were answered correctly, data and behavioral information associated with interacting with the output unit, time spent in certain modules of the output unit, results and durations of execution of certain tasks, or redirecting and accessing suggested links, other complementary output unit(s), audio or videos.

In order to track this information, the system can be configured to monitor the attendee during the presentation of the output unit. Elements such as selection devices (e.g., a mouse movement, mouse clicks, selections, answers, typed text, and the like) can be monitored to report feedback. Additional devices such as accelerometers, touch screens, and cameras can also be used to monitor an attendee during the presentation of the output unit and used to provide feedback. The communication systems and presentation on the output device can be used to collect and send the information, by using the ILS Algorithm and the Report System, from one or more attendee back to the system.

A number of additional portions of the system can be present to allow for improved learning and interaction with the system. As part of viewing or learning an output unit, a question algorithm can be used to obtain feedback on the student's progress and determine what other output units or entities may be provided by the system to the student. The entity question algorithm presents, in addition to the question statement, alternative answers, individual comments on the alternative answers, as well as the indication of which alternative answer is correct.

The answers from the entity question algorithm can be passed to a decision algorithm for evaluation of the student's performance and provide an indication, in the question decision process, of an action or actions that can be suggested, depending on which alternative answer is chosen by the student. These actions have an indication (e.g., using a link, etc.) of one or more learning path for each studen, depending on applicable pedagogic alternative adopted in each case. When the student answers a question by marking an alternative answer, the algorithm checks whether the answer was correct or not, and if not, suggests to the student which path should be followed to correctly solve the question. The path can include accessing one or more entities within the system. For example, the decision algorithm can point to any type of system entity required to help students in the learning process, including offering the option of another question to be again evaluated by the system, another class, even from another related course that can be submitted again by the decision algorithm to a new route that best adjusts to the learning path of each individual student.

An example of the type of outcomes associated with the decision algorithm are shown in FIG. 14. An initial question can be presented. If the questions are answered correctly, then subsequent questions with associated content can be presented in an order to confirm an understanding of the content. When an incorrect answer is provided, another entity may be presented to help with the learning of the subject. A correct answer to the next entity may return the student to the original set of questions. Further incorrect answers may continue to present additional entities to provide extra information on the subject to aid in the student's understanding and learning of the subject.

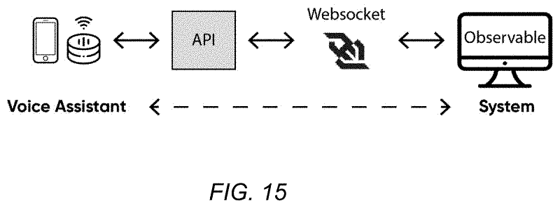

The system can present information such as the output units, entities, questions, and related activities in a number of ways. In some aspects, the system can be used with voice interaction as shown in FIG. 15. The system offers the unique capability of voice interaction between an attendee and the system, or author and system to allow voice commands and voice responses, accessing all entities in one or more languages (e.g., English, Portuguese, Italian, etc.). In addition to a traditional presentation, the system can allow for voice interaction with the system and the content displayed on the screen. In some aspects, the system's voice interaction feature can provide one or more of the following functions: the output unit can be accessed; the output unit can be read in loud voice; reply to questions by accessing any of the entities such as glossary; accessing the system and displaying information when the data is not possible to be read (figures, tables, etc.); enable or disable certain functions; searching data by key-terms; access the messaging system; access the calendar, access the any features pertaining and part of the system, read incoming messages and send messages; read the day's appointments and add reminders; open the user's calendar on the system screen or display; consult the meaning of terms and/or formulas, read them, and display the result on the system screen; display on the system screen the last class that the user accessed; display on the system screen any entity chosen by the user, acting as a menu; send questions to the tutor/teacher; notify, and/or read and display the answers to the questions sent. Other functions can also be carried out by the voice interaction, including any of those available to the student through the display and an input device such as a keyboard, mouse, pointer, touch screen, or the like.

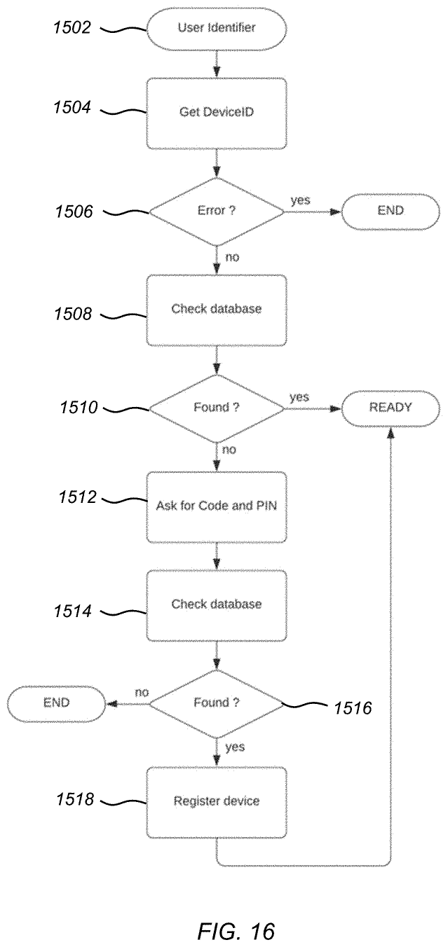

In order for the voice assistant to fulfill these functions, three conditions can be present: secure user identification, access to the database, and interaction with what is displayed by the system. User identification takes place through a process similar to a login. An exemplary identification process is shown in FIG. 16. As shown, a user identifier (e.g., a user ID) can be provided at step 1502. The device identification can also be obtained and passed to the system at step 1504. Various types of device and/or connection identifiers can be used. An error check can be performed at step 1506, and if an error exists, the process can end and the access can be denied. If there are no errors, then the user's identification can be verified in the database at step 1508. If the user identification, device identification, and code match the system record (e.g., once the user's identity is verified) at step 1510, the system can be in the ready state for use by the user. If the device ID or user code is not found, the user can provide or enters a numerical code such as a PIN number to validate the user's identity at step 1512. The numerical code can be verified within the user database at step 1514, and if the numerical code is verified at step 1516, then the user and device ID can be registered and stored within the database at step 1518. The system can then by placed in the ready state for use by the user. If the numerical code is not found or is in error, then the system can terminate the request and prevent the user from using the voice features.

Once connected, the device can remain connected to the user's account until it is explicitly disconnected from the account through a verbal command or through the activity control maintained and executed by the system. The persistent connection to the account aims to improve the user experience on the system. In some operations that require greater security, the assistant can ask for confirmation of identity through the numerical code, or in more specific cases, through a security code sent to a user's cell phone, for example via SMS or in an email.

As shown in FIG. 15, access to the database can be performed through HTTP calls from a voice assistant device to the system APIs, passing the device and user identification as parameters, which allows the validation of the user's request. Although this access can be performed asynchronously, no type of information or user data is stored on the voice assistant device, which makes its use rely on a data connection such the internet.

Interaction with the system display device such as a screen or monitor can be performed using a bridge between the two (voice assistant and system). This bridge involves APIs that receive the display command sent by the voice assistant, a WebSocket that checks if the user is logged in and accepts or rejects the command, and a system service that watches the WebSocket. When the command is sent and accepted by the WebSocket, the system service receives the information for what must be done and the specific content (if any) through the payload of the message from the WebSocket and performs the necessary operations, just as it would if the command had been provided by any component or service of the system itself

An annotation algorithm can serve to generate annotated tags that can comprise information corresponding to the nature of the content, helping searching algorithms provide data to be used as a parametric input by an author. Annotated tags serve as input information for the system to evaluate a specific module; a certain complexity level of an entity; relationship among entities such as questions, exercises, multimedia, and/or establishing entailments to other complementary activities even among inter-disciplinary ones. The system can use several data algorithms, including natural language processing algorithms, to perform tag generation and its corresponding relationship to any entity being tagged.

The annotation algorithm can export annotated texts, images, and other information to present the information in a visual format. In some aspects, the information can be presented in the form of a sticker, note, or other comments such that both to the attendee and the author can view the information within their frontend respectively.

In some aspects, the system can comprise a calendar algorithm. The calendar algorithm can store various information in a database and access the information up on request. The information can be provided as an input to various other algorithms and models. For example, the calendar algorithm can provide a comprehensive and feature rich calendar, integrated and accessed by several algorithms and entities, and made available to authors, administrators and/or attendees. The voice algorithm as described herein, in addition to other algorithms are able to access the calendar and provide reminders, by voice or otherwise, about appointments, meetings, classes, activities, scheduled valuations, tests, and the like.

A CommSatt algorithm can provide a communications service within the system. The CommSatt algorithm can be built into the AGFLS, and the algorithm can allow various users to organize meetings, chat, and place video-conference calls inside the user's organization. Using the CommSat algorithm, the organization's staff, professors, administrative staff, supervisors, etc., are able to conduct and attend online meetings with video, offering distance learning capabilities; remote classes; organization of tutoring sessions for certain attendee or group of attendees, everything with full audio control, screen sharing, meeting chat and in-room video conference to support attended classes; and/or use chat and chat rooms for communications between an author and an attendee or group of attendees. In some aspects, control and management of the CommSat sessions may only be offered to administrative users (e.g., those in the administration with proper assigned privileges) following their management policies to avoid the inadequate or unsecure use of it by certain attendees.

In some aspects, the system can comprise a built-in messaging system. The messaging system can be part of and/or in signal communication with the CommSat algorithm to allow students to send messages to their teachers and vice versa. The messaging system can also be accessed by the voice algorithm with several functionalities such as sending a message; reading a message, deleting a message already read, and the like. The messaging system can retain messages that were not read yet, for certain period of time “t” that can be established by the system administrator. For example, t can be between about 1 to 50 days, or between about 10-30 days or about 15 days. After the time “t” elapses, the system can send an alarm to the user, informing that they will be deleted after a final period (e.g., 48-72 hours). Messages that are read, can remain available for a time period (e.g., 48-72 hours) and then be deleted.

Messages sent to professors/teachers, by the voice system regarding certain types of questions from students can be displayed in a special card, accessible by the group of teachers of certain student (without the identification of the student data, name etc.) to be answered. Once the message is answered by one of the teachers, the message can be deleted from the display. The answer can be sent, by the system, to the appropriate entity related to the question asked, and also to the message box of the student that originated the question with the appropriate answer. The system interprets the relationship between the question and the entity through its entailment and relationship algorithms.

In some aspects, the system can comprise an information log system (ILS). The system maintains a record of the activities of administrative users by recording their actions within the system from the moment they log in. These actions can be recorded and can be viewed through screens or reports, however, noting that they are only accessible to high hierarchical users, not being available to most users of the system. In some aspects, all users, regardless of their level of access to the system, have their actions recorded by the ILS. The ILS also applies to the voice assistant, recording what is requested or accessed through it.

In the same way that the administrative user has his/her actions recorded, the student user also has his/her actions recorded, including, in this case, answers given to questions, task completion time, and other information of a didactic nature. This information can be used by administrative users in the pedagogical area, such as teachers, keeping the student's identification confidential when necessary. The information, also anonymously, is used by some artificial intelligence algorithms to improve student performance.

The system can generally be used based on access through a data connection. In order to allow the system to be used even in the absence of a data connection, an offline algorithm can be part of the system to allow for continued learning even when the user does not have an active data connection. The offline algorithm as described below is one the advantageous algorithms in the present systems and methods. A significant detrimental cause of the use of LMS systems, especially on distance learning, is the necessity of having a good internet connection to access the database.

Since in many countries and even in developed countries, in certain locations the ability to have a high-quality internet access is inefficient, resulting in poor or no access to data, the offline algorithm implemented herewith allows the attendee to access a set P logical pages, that are stored in S physical slots in a personal device associated with the attendee even when in transit like on a school bus, underground, at home, etc.

The set of P Logical Pages, where the current logical pages can be referred to in some context as the focus pages, can comprise two subsets. First, a subset of p's that in the past has been used as P Logical Pages, named Pp−n, where p is a constant for specific present time, that reflects a certain number of P's used in the past, that may be required for the attendee as reference in fulfilling the learning objective of a certain valid P. Second, a subset of p's that are going to be used in the near future, Pp+m, all of them with the logical conditional of a valid P. Note that m and n are arbitrary numbers larger than 1 and not necessarily equal.

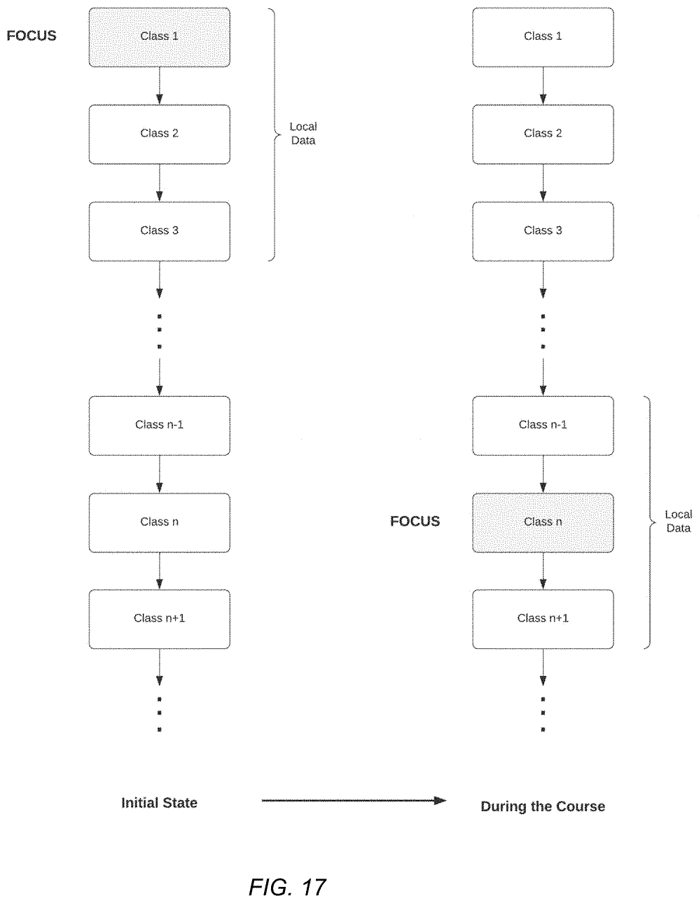

For every set of Pp−1 (from 1 to n), the offline algorithm automatically replaces each, by a new version Pp+n, whenever the device of the attendee acquires sufficient internet access. This process is shown in FIG. 17 where the pages store the local focus pages in addition to additional pages for use in the future. As the course progresses, the focus pages can advance, and the local data can be updated when an internet connection is available in order to allow the users to access the current focus pages.

Through this unique feature, the system allows attendees to study, do homework, rehearsals, exercises etc., in preparation for the next classes even when they are offline.

Offline access to data is provided by replacing the endpoint of the data files, which point to a local database, installed on the same device as the system. Because there is restricted availability of storage space and so that there is no significant performance compromise on the device, only part of the data can be kept in the local database and its content will be constantly replaced and updated when the need arises and the device is online on the network.

The content that will be kept in the local database must be sufficient for the user to be able to continue using the system without prejudice to the course or training being followed. For this, the system will always keep the material of the class being viewed at the moment and of “n” classes before and “m” classes, after this one, so that the user can advance or review the content. In addition, user tracking data, monitored by the system, will also be recorded in a local file, for later upload to system files, so that it does not get lost and can be used with the other algorithms in the system.

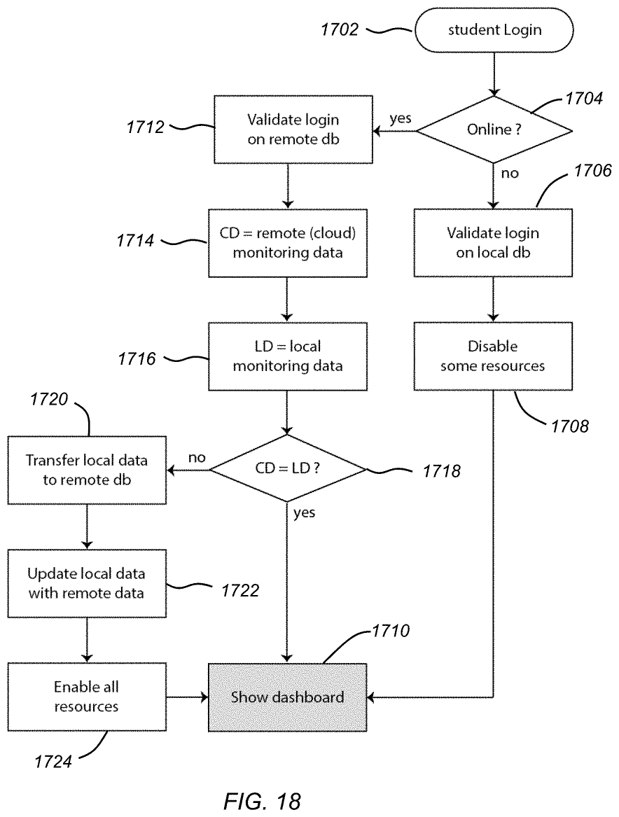

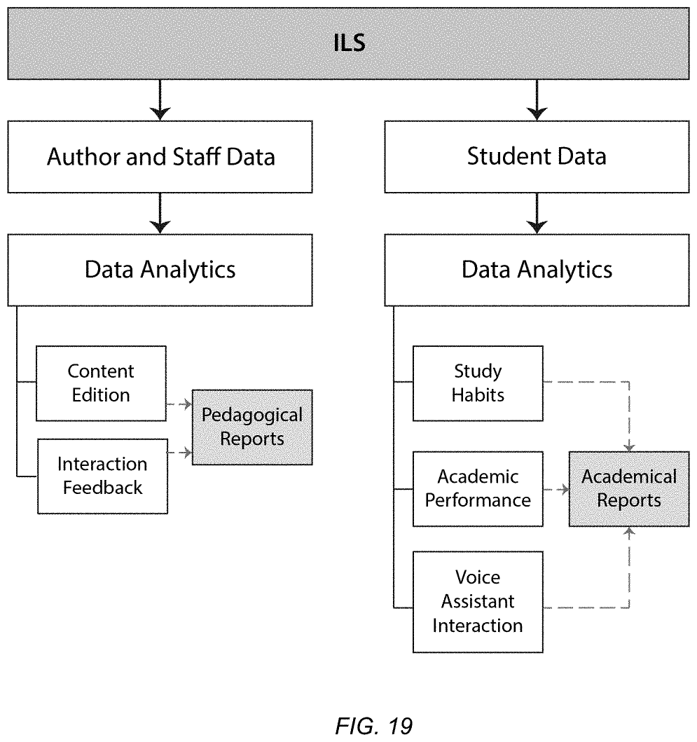

As the student progresses in the course, the current class, or focus, changes from class “n” to class “n+1” and, when placed online, the system checks which new class is “focus” and conveniently updates the content, checking what content should be replaced and what accumulated information should be transferred to and from the remote database. An embodiment of this process is shown in FIG. 18. As shown, the check can be initiated when the user logs in to the system at step 1702. Upon login, the system can determine if the device has a data connection and is online or offline at step 1704. If the system is offline, then the login can be validated using locally cached information at step 1706. If the login fails based on the locally cached information, the login can return to the login prompt at step 1702. Upon validation of the login, some resources that require an internet connection may be disabled at step 1708. For example, certain features such as messages, glossary queries, and even large media files may not be stored locally due to device characteristics, however, none of the missing features in offline mode will compromise course progress. It is anticipated that the system will be able to work regularly in offline mode without updating for a period of five days. After disabling some resources, the system will proceed to the dashboard at step 1710 and operate as described herein only with some resources disabled.

If the device is online at step 1704, then the process proceeds to step 1712 to validate the login using a remotely stored data. For example, user ID and password can be compared to remotely stored credentials to determine if the login is valid. If the login is invalid, the system can return to the login prompt at step 1702 for another login attempt. Once validated, the system can access data stored on the cloud (e.g., cloud data or CD) at step 1714. Similarly, the data stored or cached on the local device (e.g., local data or LD) can be accessed at step 1716. The system can then compare the cloud data and the local data to determine if the data is the same at step 1718. If the data is the same, the system can be considered up to date so that no updates are needed. If the data is not equivalent, then the local data, including the entities and acquired data such as answers, usage patterns, viewing times, and the like can be transferred to a remote database at step 1720. The local data can then be updated using the remote data so that the local data and remote data are equivalent at step 1722. At step 1724, any services that were disabled based on being offline can be re-enabled so that all services are available. The system can then proceed to the dashboard at step 1710. To the user, the only difference in offline use may be the loss of some services that may not affect the functionality of the system, thereby enabling offline use for those users that do not have a consistent internet connection.

In some aspects, the system can comprise a reporting system. The system can allow access to any combination of data and information that can accessed through the ILS Algorithm. The data can be accessed for the purpose allowing the generation of reports, other than those embedded in the system, by the users to fulfill their control and supervision requirements.

In general, two group of reports can be generated including reports to be reviewed by the author or the administration staff, and/or reports to be used by the pedagogic algorithm or students. As shown in FIG. 19, the author and staff reports can be processed through a data analytics algorithm or model to analyze content (e.g., blocks, entities, output units, etc.) and/or interaction reports based on student's feedback on the units. The reports can include pedagogical reports on the content and interactions with the system. Similarly, the student reports can access student data of each individual student and/or the students as a group. The reports can include information on study habits, academic performance, voice assistant interaction, and the like. In some aspects, the information may be based on an individual student's information, and/or the information may provide data on students as a group, where the data on the group may be abstracted or anonymized. For example, a comparison of all students' usage of the voice interaction system may be provided to any particular student.

In some aspects, the system may comprise a glossary that can be present as an entity within the system (e.g., an entity glossary). The glossary can help authors and attendees to access information through the use of the voice interaction system or otherwise by image, and its content (key terms and its description) are presented in the administration frontend or in the student's frontend.

The Glossary can also be accessed and used with the system's tagger algorithms to generate annotated tags that are used in the entailment algorithm to establish relationship among entities.

In some aspects, the glossary can have a classification algorithm accessible to authors that establishes certain group of terms that have special meaning within certain context, increasing the accuracy of the relationship among entities.

The content (e.g., the materials) that compose or form a lecture can be stored in a memory such as a database and be organized according to each entity, based on its specific properties. For example, the content can be stored and organized as text, images, videos, questions, exercises, formulas, math equations, glossary, and the like, and be hierarchically and relationally classified. The system and methods provide full access to the database and output units when the attendee is online and selectively access to a portion of a required database that is made accessible by the offline algorithm.

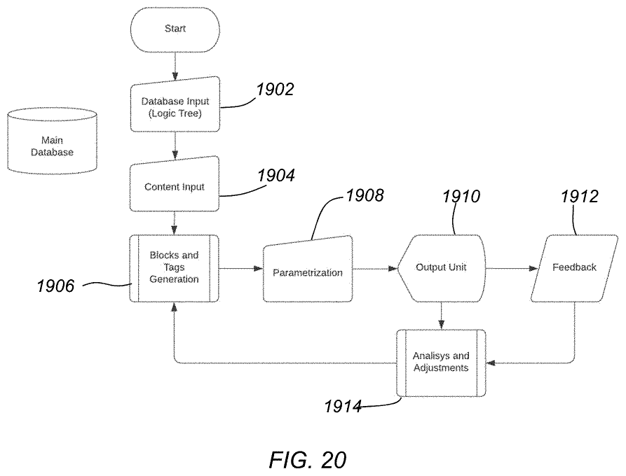

The system can be implemented as a Software as a Service (SaaS) system and is implemented in a cloud computing network, for the sake of security, performance and availability, automatically balancing the load, in accordance with the demand, and adjusting the computer processing power required by QoS of the system, in real time, drastically reducing the overhead of the processing power of attendee's devices. Other aspects of some implementation of the system are described herein with respect to FIG. 20.

In use, the system can accept various parameter inputs and use those along with the available content to assemble or generate one or more output units. Referring to the process illustration of FIG. 20, the process of generating an output unit can comprise inputting, in a database, a logic tree at step 1902. This process can include the Author defining the structural hierarchy and relationship between the components of the certain content. Any of the elements described herein can be used to define the parameters and structure of the hierarchy. The initial set of parameters can be referred to as the author's inputs in some contexts.

The method can then comprise the system accepting or accessing available content and entities at step 1904. If no content is available, the content can be input by an author. In some aspects, an existing set of content such as text, books, multimedia resources, and the like may be available in the database of content. In this instance, the author can select which content should be used by the system as part of the output unit generation. The ability to control the loading and/or selection of available content as the starting materials may help the author to control the final products. This can help to avoid issues with copyrights and other time-consuming activities surrounding the content curation process.

Using the author's inputs along with the content, one or more blocks can be generated by the system at step 1906. The blocks can be generated by the models, such as the search and organization engine using the author's inputs to execute on the content. The process results in the interpretation of the semantic, syntactic, logic and pedagogical characteristics of the content. The generation of blocks and tags use several automatic algorithms to identify and define the minimum, coherent and logically appropriate, division of each segment of the content, to allow full flexibility and accessibility to the author in the process of assembling certain desired output unit offering, including, statistical algorithms to evaluate the duration of each bock and indicating, to the author, the total duration of the blocks assembled for each specific output unit. Each kind of output unit may be designed to addressed to certain specific pedagogic objectives, chosen by the author, through the parametric strings, identifying the complexity of the subjects. Depending on the complexity of the subjects, i.e., the system is able to infer, statistically, how much time is required for the attendee to appropriately grasp the contents of that output unit. If the content is just informative, for example, the system determines that an average of 120 words per minute (WPM) shall be automatically inserted in the evaluation of the duration of the block. If the output unit content, in the other hand, is to address subjects that attendees needs to memorize, or refers to advancement placement contents, the system can allocate automatically more time to the block by enabling a small WPM (such as 80) adjusting this parameter to optimize the understanding, perception of details in entities such as figures, tables and, 3D objects that shall have the exposure time properly adjusted guaranteeing the acquisition of the information by the Attendee. The ability of the author to provide the inputs allows for flexibility and control when assembling and generating the one or more output units.

The method can also comprise the parametrization of resulting output units at step 1908. The system allows the parameters to be chosen by the author. The ability to select the parameters enables the appropriate assembling of an output unit considering all aspects of the attendee or group of attendees to whom the output unit is tailored. The algorithm, through intelligent searches, locates the different types of existing blocks and, according to their relevance to the requested subject, constructs the output unit in a coherent and pedagogic output document. The output unit can be presented to the author, who may edit, if required, to allow a comment or the addition of a whole or a part of another source text, or any newly defined entity.

The result can be the generation of one or more output units at step 1910. As part of the output unit generation, he system can automatically format the content, in a logical and pedagogical sequence, generating an output unit that can be viewed on different devices such as smartphones, tablets, computers, smart TV, in addition to being able to be exported to a print format and on reader devices.

The attendee who visualizes the output unit has his or her behavior also analyzed by the system as a form of feedback, through a set of the automatic information gathering, such as duration of time spent to complete lecture, or any task such as the resolution of problems and correctness of answering certain proposed questions, how long and how many times are spent watching videos, if in its entirety or partially, listening to audios completely or partially, using tools, such as a calculator or search engine, as well as the number of accesses to the same lecture, among others appropriate metrics. Various metrics that can include feedback can include, but are not limited to: how the attendee is dealing with the output unit in terms of comprehension of the subject, how long the attendee took to reply a proposed question, how many times he scrolled certain concepts, figures, multimedia entities, etc., whether or not the attendee accessed other output units while in one specific output unit, how effectively an attendee answered and/or executed the tasks proposed.

All actions the attendee executed during certain session that are important for the author to evaluate the level of each and every attendee at each and every moment he is exposed by certain output unit. Based on information gathering and using artificial intelligence to analyze the feedback, the system draws a profile of the attendee and suggests to the attendee and his tutor, the best logical paths to increase the productivity and the attendee's understanding of that subject, in addition, to generate performance reports to the author and his/her supervisors.

The method an include the evaluation of the output unit and adjustments in the parametrization in step 1914. Once the output is generated, it can be submitted to certain AI algorithms to perform various analysis and adjustments, which can fine tuning of the set of parameters to be used in the generation of the output unit. The algorithms can accept the output unit generated at step 1910 along with feedback generated at step 1912 from the attendee or group of attendees and generate an output indicative of elements used to improve the generation of the blocks at step 1906. The resulting analysis loop can allow the process for optimization to be repeated for each set of parameters. Within the learning loop, statistical learning algorithms can be applied to implement rational agents acting in the optimization loop.

Once the output unit generation process is complete, the attendees or group of attendees can be exposed to the resulting output unit. This can allow an improved or the best output unit possible and appropriate, to each and every attendee and group of attendees.

Additional functionality can also be present in the system. For example, the system can generate system reports to the author detailing activities of each attendee or a group of attendees using the feedback. This can allow a better understanding and audit the behavior and use of every component of the system. In some aspects, the author may adjust the parameters and/or the algorithms for the content analysis or block generation can be updated based on the feedback from the attendees.

The reports generated can comprise personal performance information, ranging from how many and which answers to questions were answered correctly, to data and behavioral information operating the system, such as time spent in certain modules within an Output Unit, results and duration of execution of certain tasks, redirecting and accessing suggested links, visualization of videos, etc. In addition, the system can provide statistical reports for groups of attendees, in these cases, ensuring the privacy of attendee's personal information, for example, by aggregating and anonymizing the data.

As the system is applied to each attendee or certain group of attendees, the feedback mechanisms within the system can allow the system to “learn” the specificity of the attendees and offers fully automatic and optimized learning paths, guaranteeing the uniqueness of each pedagogic tool and entities that are to be applied, at any instant, to the attendee. This can allow for information to be presented at a tailored pace while ensuring a desired level of understanding.

The system and methods described herein provide for various advantages over other systems. The growing number of formal and informal learning options, causing an unbundling of the Author role, has been addressed by the Invention through the automation of activities that happens in any premises—classroom, auditorium, labs, etc.—bringing all the benefits of blended models to attendees, offering the experience of multiple learning modalities originating from the adRoot content or others multiple sources; generating options such as content oriented sessions; group discussion sessions; project design to supplement online sessions; hands-on application of contents; mentorship sessions to provide wisdom and social capital; guidance evaluators to provide grading to assignments and designing assessments.

The system also provides value added opportunity to authors allowing automatic access to extensive and intensive recommendations of complementary activities to enhance each and every one of attendee by automatic evaluation of the metrics obtained from the content sessions.

The scope of the system is broad and can be applied by any educational institutions such as Schools, Universities, independent training enterprises, such as Foreign Language Schools, extensions courses, generic training and skills development programs, etc.

The system can be used with any language and output unit format.

Implementations of certain tools and interfaces to appropriately access the enhanced database to deal with 3D objects and virtual reality will be incorporated in the system to increase attendee's engagement and experiences.

Additional advantages can include:

The system provides all the functionalities related to the sharing and administration of content and users.

The system implements a turn-key solution that allows a huge time and efficiency gain on the part of the author.

The system presents the output unit and content to the attendee in an easy, fast, coherent and operationally pleasant way. To accomplish all this functionality the system has been provided with a comprehensive collection of contents of all sorts, guaranteeing the quality and reliability of the information, as well as its right to use.

Each and every piece of content has been introduced in the system to compose entities that will be analyzed by system's algorithms in the search for content that presents only and guaranteed relevant results.

All information can be obtained through the access to data stored in the database and, for the sake of integrity and security, no outside content can be accessed from the system unless it has been parametrized and appropriately approved to be part of the adRoot.

Once the searched contents are found, the system automatically formats the content, in a logical and pedagogical sequence, generating an output unit that can be viewed on different devices: smartphones, tablets, computers, smart TV, in addition to being able to be exported to a print format and on reader devices.

The system collects a large amount of information about attendee behavior and learning characteristics, processing it, using artificial intelligence algorithms, in order to present it not only to the attendee's tutor, but automatically suggesting to the attendee what actions can be taken to maximize his performance.

The system offers the unique capability of voice interaction between attendee and the system, or author and system to allow voice commands and voice responses, accessing all entities in any suitable language. Through voices commands the output unit can be accessed; be read in loud voice; replying questions by accessing any of the entities such as glossary; enable or disable certain functions; searching data by key-terms; voice messaging, all features pertaining and part of the system.

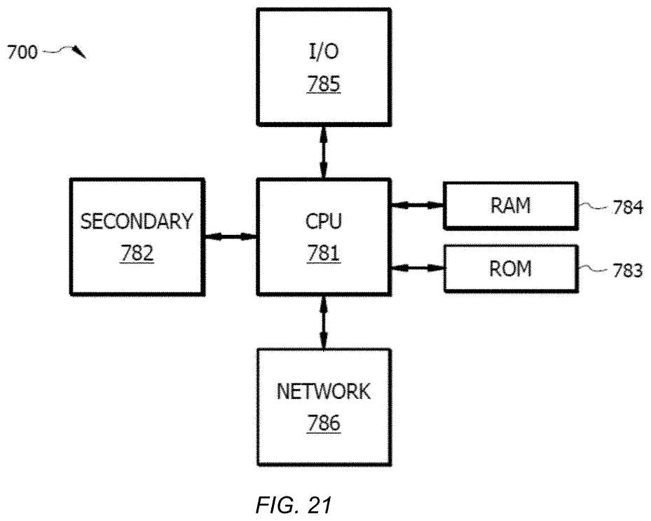

Any of the systems and methods disclosed herein such as the image capture device, the edge device, and the computing on the cloud computing component can be carried out on a computer or other device comprising a processor. FIG. 21 illustrates a computer system 700 suitable for implementing one or more embodiments disclosed herein. The computer system 700 includes a processor 781 (which may be referred to as a central processor unit or CPU, a computing or processing node, etc.) that is in communication with memory devices including secondary storage 782, read only memory (ROM) 783, random access memory (RAM) 784, input/output (I/O) devices 785, and network connectivity devices 786. The processor 781 may be implemented as one or more CPU chips.

It is understood that by programming and/or loading executable instructions onto the computer system 700, at least one of the processor 781, the RAM 784, and the ROM 783 are changed, transforming the computer system 700 in part into a particular machine or apparatus having the novel functionality taught by the present disclosure. It is fundamental to the electrical engineering and software engineering arts that functionality that can be implemented by loading executable software into a computer can be converted to a hardware implementation by well-known design rules. Decisions between implementing a concept in software versus hardware typically hinge on considerations of stability of the design and numbers of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable that will be produced in large volume may be preferred to be implemented in hardware, for example in an application specific integrated circuit (ASIC), because for large production runs the hardware implementation may be less expensive than the software implementation. Often a design may be developed and tested in a software form and later transformed, by well-known design rules, to an equivalent hardware implementation in an application specific integrated circuit that hardwires the instructions of the software. In the same manner as a machine controlled by a new ASIC is a particular machine or apparatus, likewise a computer that has been programmed and/or loaded with executable instructions may be viewed as a particular machine or apparatus.

Additionally, after the computer system 700 is turned on or booted, the processor 781 may execute a computer program or application. For example, the processor 781 may execute software or firmware stored in the ROM 783 or stored in the RAM 784. In some cases, on boot and/or when the application is initiated, the processor 781 may copy the application or portions of the application from the secondary storage 782 to the RAM 784 or to memory space within the processor 781 itself, and the processor 781 may then execute instructions that the application is comprised of In some cases, the processor 781 may copy the application or portions of the application from memory accessed via the network connectivity devices 786 or via the I/O devices 785 to the RAM 784 or to memory space within the processor 781, and the processor 781 may then execute instructions that the application is comprised of. During execution, an application may load instructions into the processor 781, for example load some of the instructions of the application into a cache of the processor 781. In some contexts, an application that is executed may be said to configure the processor 781 to do something, e.g., to configure the processor 781 to perform the function or functions promoted by the subject application. When the processor 781 is configured in this way by the application, the CPU 782 becomes a specific purpose computer or a specific purpose machine.

The secondary storage 782 is typically comprised of one or more disk drives or tape drives and is used for non-volatile storage of data and as an over-flow data storage device if RAM 784 is not large enough to hold all working data. Secondary storage 782 may be used to store programs which are loaded into RAM 784 when such programs are selected for execution. The ROM 783 is used to store instructions and perhaps data which are read during program execution. ROM 783 is a non-volatile memory device which typically has a small memory capacity relative to the larger memory capacity of secondary storage 782. The RAM 784 is used to store volatile data and perhaps to store instructions. Access to both ROM 783 and RAM 784 is typically faster than to secondary storage 782. The secondary storage 782, the RAM 784, and/or the ROM 783 may be referred to in some contexts as computer readable storage media and/or non-transitory computer readable media.

I/O devices 785 may include printers, video monitors, liquid crystal displays (LCDs), LED displays, touch screen displays, keyboards, keypads, switches, dials, mice, track balls, voice recognizers, card readers, paper tape readers, or other well-known input devices.

The network connectivity devices 786 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards that promote radio communications using protocols such as code division multiple access (CDMA), global system for mobile communications (GSM), long-term evolution (LTE), worldwide interoperability for microwave access (WiMAX), near field communications (NFC), radio frequency identity (RFID), and/or other air interface protocol radio transceiver cards, and other well-known network devices. These network connectivity devices 786 may enable the processor 781 to communicate with the Internet or one or more intranets. With such a network connection, it is contemplated that the processor 781 might receive information from the network, or might output information to the network (e.g., to an event database) in the course of performing the above-described method steps. Such information, which is often represented as a sequence of instructions to be executed using processor 781, may be received from and outputted to the network, for example, in the form of a computer data signal embodied in a carrier wave.

Such information, which may include data or instructions to be executed using processor 781 for example, may be received from and outputted to the network, for example, in the form of a computer data baseband signal or signal embodied in a carrier wave. The baseband signal or signal embedded in the carrier wave, or other types of signals currently used or hereafter developed, may be generated according to several methods well-known to one skilled in the art. The baseband signal and/or signal embedded in the carrier wave may be referred to in some contexts as a transitory signal.

The processor 781 executes instructions, codes, computer programs, scripts which it accesses from hard disk, floppy disk, optical disk (these various disk-based systems may all be considered secondary storage 782), flash drive, ROM 783, RAM 784, or the network connectivity devices 786. While only one processor 781 is shown, multiple processors may be present. Thus, while instructions may be discussed as executed by a processor, the instructions may be executed simultaneously, serially, or otherwise executed by one or multiple processors. Instructions, codes, computer programs, scripts, and/or data that may be accessed from the secondary storage 782, for example, hard drives, floppy disks, optical disks, and/or other device, the ROM 783, and/or the RAM 784 may be referred to in some contexts as non-transitory instructions and/or non-transitory information.

In an embodiment, the computer system 700 may comprise two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the computer system 700 to provide the functionality of a number of servers that is not directly bound to the number of computers in the computer system 700. For example, virtualization software may provide twenty virtual servers on four physical computers. In an embodiment, the functionality disclosed above may be provided by executing the application and/or applications in a cloud computing environment. Cloud computing may comprise providing computing services via a network connection using dynamically scalable computing resources. Cloud computing may be supported, at least in part, by virtualization software. A cloud computing environment may be established by an enterprise and/or may be hired on an as-needed basis from a third party provider. Some cloud computing environments may comprise cloud computing resources owned and operated by the enterprise as well as cloud computing resources hired and/or leased from a third party provider.

In an embodiment, some or all of the functionality disclosed above may be provided as a computer program product. The computer program product may comprise one or more computer readable storage medium having computer usable program code embodied therein to implement the functionality disclosed above. The computer program product may comprise data structures, executable instructions, and other computer usable program code. The computer program product may be embodied in removable computer storage media and/or non-removable computer storage media. The removable computer readable storage medium may comprise, without limitation, a paper tape, a magnetic tape, magnetic disk, an optical disk, a solid state memory chip, for example analog magnetic tape, compact disk read only memory (CD-ROM) disks, floppy disks, jump drives, digital cards, multimedia cards, and others. The computer program product may be suitable for loading, by the computer system 700, at least portions of the contents of the computer program product to the secondary storage 782, to the ROM 783, to the RAM 784, and/or to other non-volatile memory and volatile memory of the computer system 700. The processor 781 may process the executable instructions and/or data structures in part by directly accessing the computer program product, for example by reading from a CD-ROM disk inserted into a disk drive peripheral of the computer system 700. Alternatively, the processor 781 may process the executable instructions and/or data structures by remotely accessing the computer program product, for example by downloading the executable instructions and/or data structures from a remote server through the network connectivity devices 786. The computer program product may comprise instructions that promote the loading and/or copying of data, data structures, files, and/or executable instructions to the secondary storage 782, to the ROM 783, to the RAM 784, and/or to other non-volatile memory and volatile memory of the computer system 700.

In some contexts, the secondary storage 782, the ROM 783, and the RAM 784 may be referred to as a non-transitory computer readable medium or a computer readable storage media. A dynamic RAM embodiment of the RAM 784, likewise, may be referred to as a non-transitory computer readable medium in that while the dynamic RAM receives electrical power and is operated in accordance with its design, for example during a period of time during which the computer system 700 is turned on and operational, the dynamic RAM stores information that is written to it. Similarly, the processor 781 may comprise an internal RAM, an internal ROM, a cache memory, and/or other internal non-transitory storage blocks, sections, or components that may be referred to in some contexts as non-transitory computer readable media or computer readable storage media.

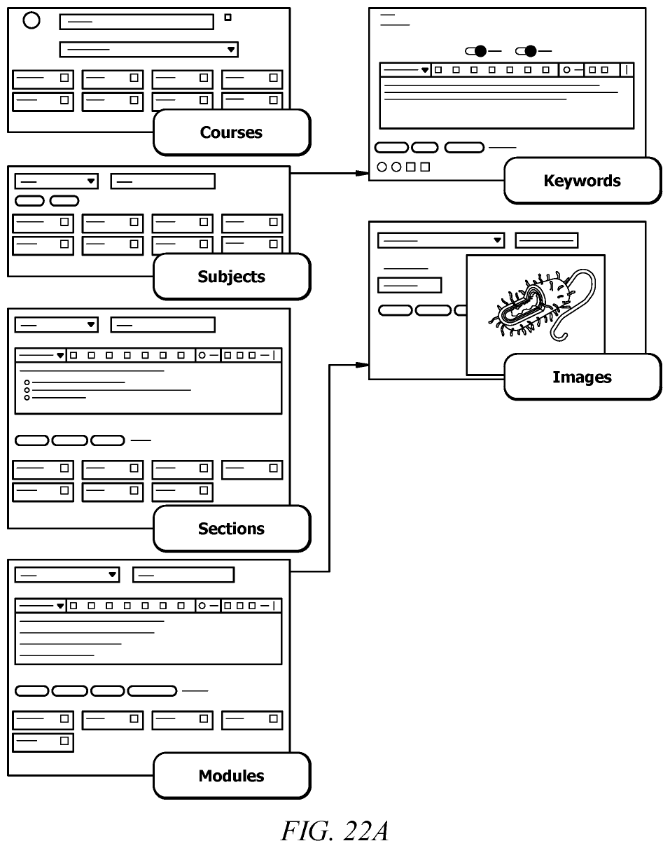

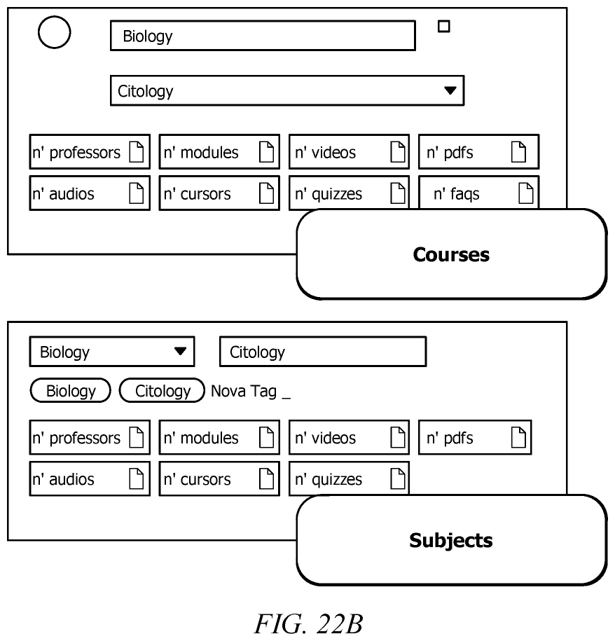

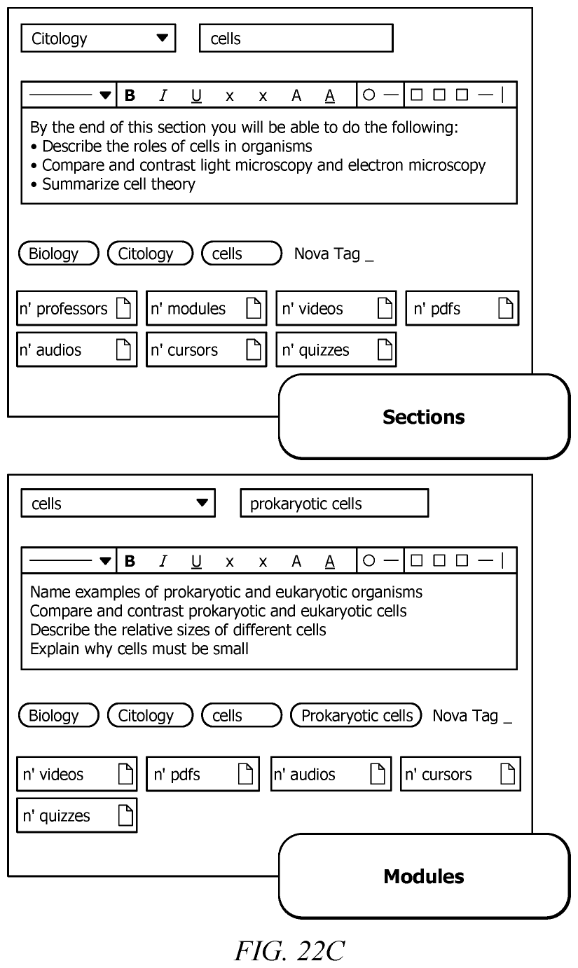

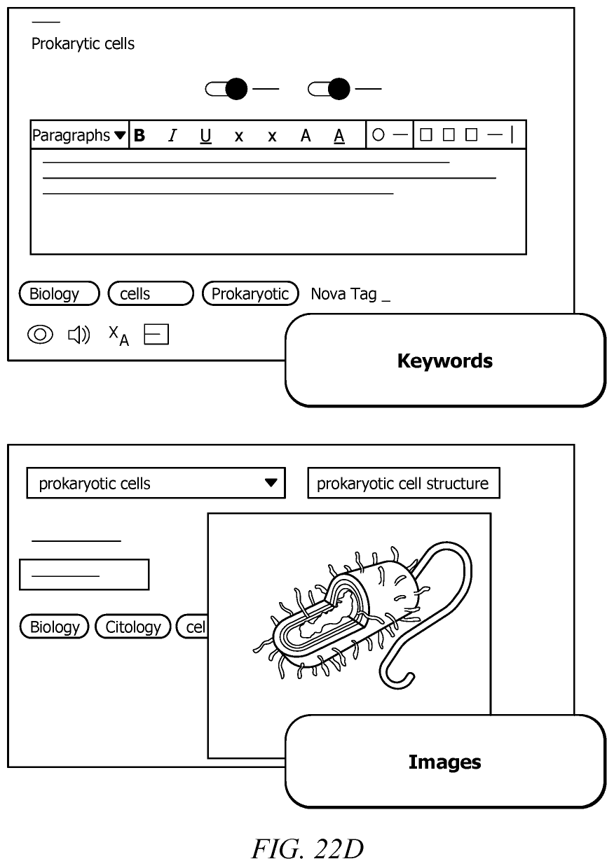

As shown in FIG. 22A, the input parameters can be provided as one or more of courses, subjects, sections, and modules as described herein. In this example, the inputs are provided using a combination of text and selection menus. Within this process, blocks, questions, glossary, etc., can also be identified as being part of the relevant inputs and information. These inputs allow the author to define the hierarchical structure and relationship of the content. FIGS. 22B-22D provided expanded view of the input parameter information as shown in FIG. 22A.

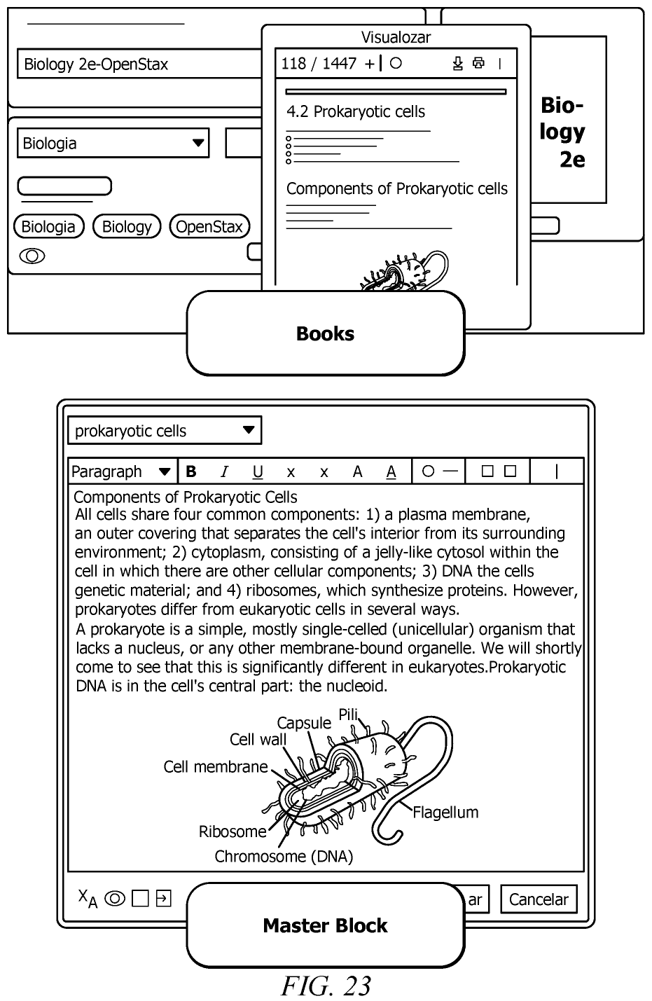

FIG. 23 illustrates an example of a book being used as a source material. As shown the book can have the information organized according to the original structure. Also, as shown in FIG. 2, the book can include both headings, text associated with the headings, and images associated with the text and headings. The system can access the book and extract master blocks as shown in FIG. 23. The master blocks maintain the integrity of the concept. In this example, the master block is extracted and contains the information concerning a prokaryotic cell, including the text and image. While only one master block is shown in the example of FIG. 23, the system can extract many different master blocks for use in creating the output.

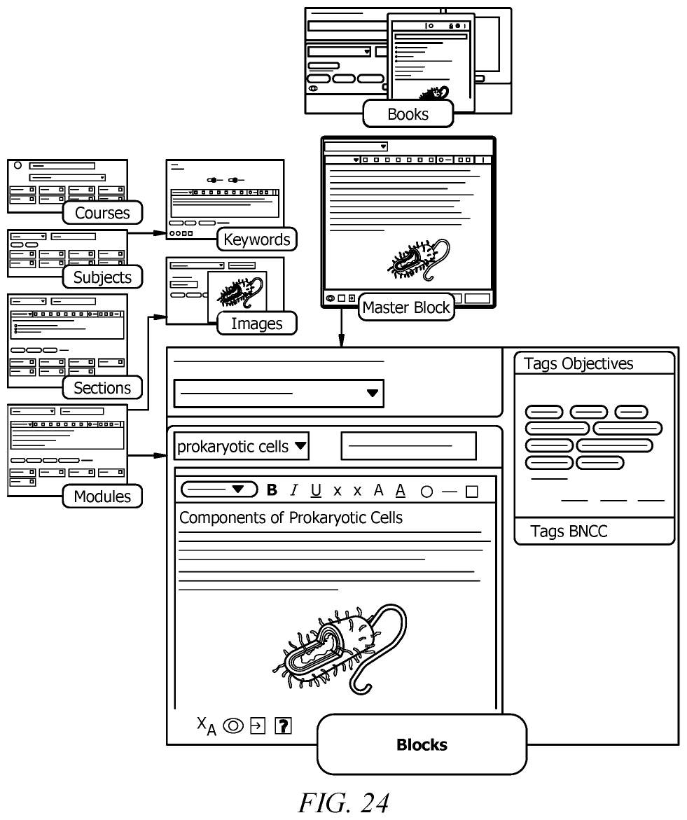

FIG. 24 illustrates the tagging process within this example. As shown, the master block is processed, and tags are generated based on the content of the master block. In the example shown, the tags can include keywords as well as hierarchical definitions for use with the inputs. The tags can be associated with the block to allow later identification and use of the block. As shown, the tags in this example can include various labels such as biology, cells, prokaryotic cells, plasma membranes, and the like.

FIG. 24 also demonstrates that the input parameters can form part of the block generation and tagging. Specifically, the hierarchical structure and definitions can be used as attributes upon which the models can operate to categorize and assign the inputs to each master block generated from the content such as the book in this case. As a result, the tags can comprise information and labels corresponding to the input parameters, where the tags can be automatically generated by the system without input from an author.

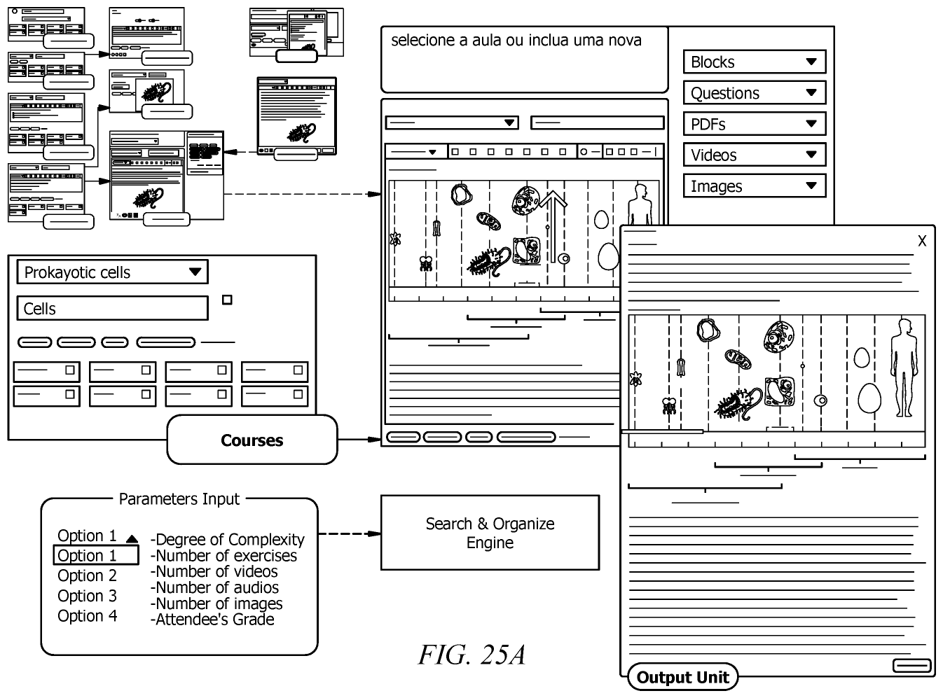

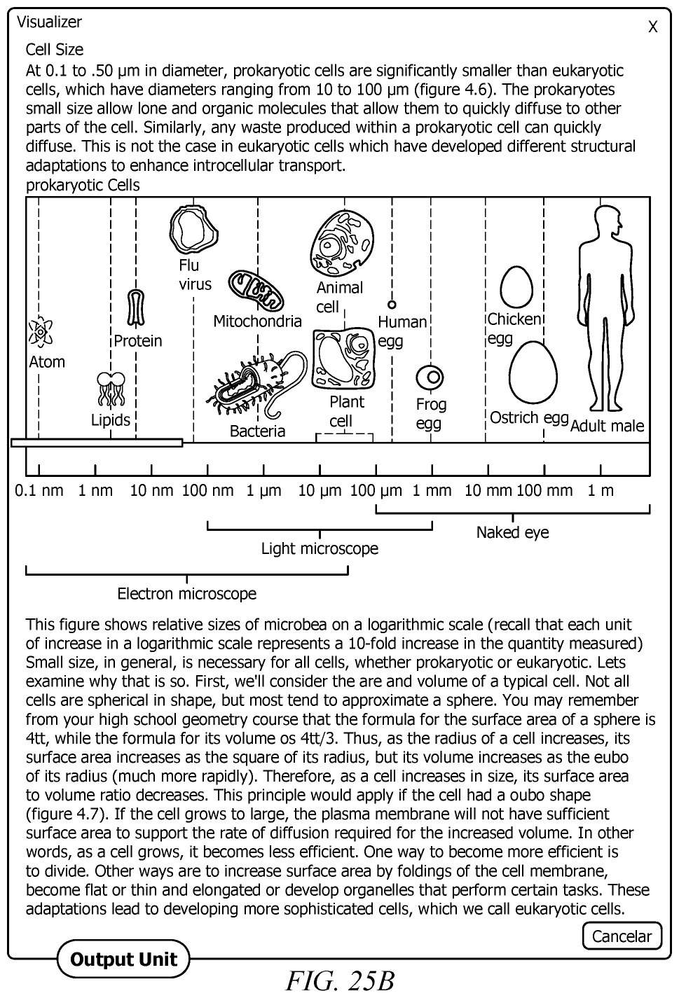

FIGS. 25A and 25B then show the use of the search and organization engine to form an output unit. The engine uses the selected inputs as provided in FIGS. 22A-22D along with the blocks and associated tags to assemble a plurality of the blocks to form information on a selected topic as defined in the input parameters. FIG. 25A demonstrates an output unit created on “cell size” using the block generated for prokaryotic cells. FIG. 25B illustrates a larger view of the resulting output unit. In this example, the system generated the output unit on cell size using information on specific cells collected from the source material(s). FIG. 25A demonstrates that the resulting output unit can be edited by an author once it is automatically generated. While an author can edit the output unit, the output unit can also be used as provided by the system. As described herein, an author can revise the input parameters and regenerate the output unit using the same set of blocks having associated tags to generate a similar output unit (e.g., for the same subject) having different content based on the changed input parameters.

The resulting output unit in FIG. 25B illustrates a number of elements of the system and corresponding output unit generated from the system. First, the blocks and corresponding information concerning the blocks can be reassembled to provide an output unit such as a lecture or presentation on a different subject matter. As shown in FIG. 25B, information concerning a variety of information on different cells can be assembled based on blocks having information for specific cells. Further, in this example, the image extracted from the block can be reassembled along with images from other blocks to form new images. In this example, the image of the prokaryotic cell can be placed into a collage or graph having relevant axes along with images of other cells to convey information on cell size. While FIG. 25B illustrates the text being assembled and the images being used, other aspects of the source material such as audio files, videos, multimedia, and the like can also be extracted as separate blocks or information associated with text or image files and assembled as part of the output unit.

This example demonstrates that the source material can be ingested by the system along with various input parameters arranged in a hierarchical organization. The system can operate on the source material using the hierarchical structure to intelligently and automatically generated blocks. Based on specific inputs and selections by an author, the system can then generate an output unit using the blocks to assemble the desired information according to the inputs on the desired information. The process can be supervised by the author to ensure that the automatic generation of the content fits within the defined parameters. This system then allows for specific information on desired topics to be quickly and efficiently generated without a manual process, and in ways that would not be easy for a person to perform or update based on changed needs or inputs.

It should be understood that the system can generate one or more output units, which can also be used to form or compose a book or text resembling a traditional text book. For example, the system can export the information in an appropriate format with the classes from a course to form the book. As an example, if the authors of a certain book wanted to develop and make available for printing or in e-book format, all of the content for a book in addition to all of the classes, including questions, exercises, activities, evaluation tests, and any associated multimedia entities to be used in the courses by other teachers/professors, the system can automatically generate the content and form the book. This ability can add a new tool in the presentation of books for education purpose, enhancing their use, and allowing the books to be sold through the appropriate channels.

Having described various systems and methods herein, certain aspect can include, but are not limited to:

In a first aspect, a method of generating an educational output unit comprises: analyzing, using a machine learning module, content based on a logic tree, wherein the logic tree comprises a structural hierarchy for the content; generating a plurality of blocks; associating tags with each block of the plurality of blocks; and assembling the plurality of blocks into an output unit based on one or more parameters and the tags.

A second aspect can include the method of the first aspect, further comprising: sending the output unit to an evaluation unit; updating, by the evaluation unit, the one or more parameters to generate updated parameters; and updating the output unit using the updated parameters.

A third aspect can include the method of the first or second aspect, further comprising: receiving feedback on the updated output unit; and updating the output unit based on the feedback.

A fourth aspect can include the method of the third aspect, wherein the feedback comprises at least one of: how many and which answers to questions were answered correctly, data and behavioral information associated with interacting with the output unit time spent in certain modules of the output unit, results and durations of execution of certain tasks, or redirecting and accessing suggested links or videos.

A fifth aspect can include the method of any one of the first to fourth aspects, wherein each block includes content that maintains the integrity of the meaning of a concept.

In a sixth aspect, a method of generating an educational output unit comprises: accessing, by a processor, content, wherein the content comprises information related to a subject; receiving an input comprising a logic tree, wherein the logic tree comprises a structural hierarchy for the content; analyzing, using a machine learning module, the content based on a logic tree; generating a plurality of blocks, wherein the plurality of blocks comprises at least two blocks from different sections of the content; associating tags with each block of the plurality of blocks; and assembling the plurality of blocks into an output unit based on one or more parameters and the tags.

A seventh aspect can include the method of the sixth aspect, wherein the content comprises a plurality of works related to the subject, and wherein the output unit comprises the at least two blocks from different works.

An eighth aspect can include the method of the sixth or seventh aspect, wherein the output unit comprises a new work composed of the at least two blocks of the plurality of blocks.

A ninth aspect can include the method of any one of the sixth to eighth aspects, further comprising: sending the output unit to an evaluation unit; updating, by the evaluation unit, the one or more parameters to generate updated parameters; and updating the output unit using the updated parameters.

A ninth aspect can include the method of any one of the sixth to ninth aspects, further comprising: receiving feedback on the updated output unit; and updating the output unit based on the feedback.

An eleventh aspect can include the method of the tenth aspect, wherein the feedback comprises at least one of: how many and which answers to questions were answered correctly, data and behavioral information associated with interacting with the output unit time spent in certain modules of the output unit, results and durations of execution of certain tasks, or redirecting and accessing suggested links or videos.

A twelfth aspect can include the method of the tenth or eleventh aspect, further comprising: generating a second output unit based on the feedback.

A thirteenth aspect can include the method of any one of the sixth to eleventh aspects, wherein each block includes content that maintains the integrity of the meaning of a concept.

In a fourteenth aspect, a method of generating an output unit comprises: receiving an input unit, wherein the input unit comprises content; receiving input parameters, wherein the input parameters define need and objectives of multiple individual attendees or a group of attendees; and generating an output unit based on the input unit and the input parameters.

A fifteenth aspect can include the method of the fourteenth aspect, wherein generating the output unit comprises: generating a plurality of blocks from the input unit based on a hierarchical data structure; and compiling a selection of blocks of the plurality of blocks based on the input parameters.

A sixteenth aspect can include the method of the fifteenth aspect, wherein generating the plurality of blocks comprises: selecting a plurality of portions of the input unit; classifying each portion of the plurality of portions using a machine learning model and the hierarchical data structure; and tagging each portion of the plurality of portions with one or more identifiers, where each block of the plurality of blocks comprises each portion of the plurality of portions tagged with the one or more identifiers.

A seventeenth aspect can include the method of any one of the fourteenth to sixteenth aspects, further comprising: receiving a text string comprising one or more words; formatting the one or more words within the text strings to generate search keys, wherein the search keys comprise text keys and phonetic keys; searching a plurality of entities; identify one or more results based on the searching; receive a selection of at least one of the one or more results; and incorporating the at least one of the one or more results into the output unit.

An eighteenth aspect can include the method of the seventeenth aspect, wherein the text keys and the phonetic keys are determined from the one or more words.

A nineteenth aspect can include the method of the seventeenth or eighteenth aspect, further comprising: scoring the one or more results using the text keys and the phonetic keys; and ranking the results based on the scoring.

A twentieth aspect can include the method of the nineteenth aspect, wherein the ranking based on the scoring is stored with the output unit.

In a twenty first aspect, a method of accessing a learning management system using a voice interface comprises: receiving, by an application programming interface (API) of a processing system, a command from a voice assistant, wherein the voice command is configured to respond to vocal input; passing, from the API, the command to a web socket; accepting, by the web socket, the command; receiving, by the web socket, data associated with the command; monitoring, by a system service of the processing system, the websocket; accepting, by the system service, the command and data in response to the web socket accepting the command; and performing the command using the data in response to accepting the command and data.

A twenty second aspect can include the method of the twenty first aspect, wherein performing the command comprises displaying data on a display.

A twenty third aspect can include the method of the twenty first or twenty second aspect, wherein the command is an HTTP call.

A twenty fourth aspect can include the method of any one of the twenty first to twenty third aspects, wherein the HTTP call comprises a device identification of the voice assistant and a user identification.

A twenty fifth aspect can include the method of any one of the twenty first to twenty fourth aspects, wherein performing the command comprises accessing a learning management system and displaying an output unit.

A twenty sixth aspect can include the method of any one of the twenty first to twenty sixth aspects, wherein the voice assistant is configured to accept the command in a plurality of languages.

A twenty seventh aspect can include the method of any one of the twenty first to twenty sixth aspects, wherein the command comprises at least one of: a command to access an output unit; a command to read an output unit; a command to reply to a question; a command to access the system and display information; a command to enable one or more functions; a command to search data by key-terms; a command to access a messaging system; a command to access a calendar, a command to read an incoming message; a command to send one or more messages; a command to read a list of appointments; a command to open a user's calendar on a system screen or display; a command to display on a system screen a last class that a user accessed; a command to display on a system screen an entity chosen by the user; or a command to send questions to a/teacher.

In a twenty eighth aspect, a method of providing an output unit comprising learning materials comprises: accessing a plurality of output units over an internet connection; caching the plurality of output units in a local storage, wherein each output unit of the plurality of output units comprise learning materials; ceasing the internet connection so that the internet connection is offline; accessing and displaying one or more of the plurality of output units while the internet connection is offline; and storing user input while the internet connection is offline.

A twenty ninth aspect can include the method of the twenty eighth aspect, further comprising: restoring the internet connection; comparing, using the internet connection, the plurality of output units in the local storage with a second plurality of output units in a remote storage; synchronizing the plurality of output units and the second plurality of output units; transferring the user input to the remove storage; and providing at least one output unit of the second plurality of output units to a user using the internet connection.

A thirtieth aspect can include the method of the twenty eighth or twenty ninth aspect, further comprising: disabling one or more services while the internet connection is offline; and restoring the one or more services when the internet connection is restored.

While the operations of the various methods described herein have been discussed and labeled with numerical reference, in various examples the methods include additional operations that are not recited herein. In some examples any one or more of the operations recited herein include one or more sub-operations. In some examples any one or more of the operations recited herein is omitted. In some examples any one or more of the operations recited herein is performed in an order other than that presented herein (e.g., in a reverse order, substantially simultaneously, overlapping, etc.). Each of these alternatives is intended to fall within the scope of the present disclosure.

As used within the written disclosure and in the claims, the terms “including” and “comprising” (and inflections thereof) are used in an open-ended fashion, and thus should be interpreted to mean “including, but not limited to.” Unless otherwise indicated, as used throughout this document, “or” does not require mutual exclusivity, and the singular forms “a,” “an,” and “the” are intended to include the plural forms as well, unless the context clearly indicates otherwise.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. Further, the steps of the methods described herein may be carried out in any suitable order, or simultaneously where appropriate. The terminology used herein was chosen to best explain the principles of the embodiments, the practical application or technical improvement over technologies found in the marketplace, or to enable others of ordinary skill in the art to understand the embodiments disclosed herein.

1. The method of claim 14, further comprising:
analyzing, using a machine learning module, the content based on a logic tree, wherein the logic tree comprises a structural hierarchy for the content;
generating a plurality of blocks based on the analyzing;
associating tags with each block of the plurality of blocks; and
assembling the plurality of blocks into an output unit based on the input parameters and the tags.

2. The method of claim 1, further comprising:
sending the output unit to an evaluation unit;
updating, by the evaluation unit, the one or more parameters to generate updated parameters; and
updating the output unit using the updated parameters.

3. The method of claim 1, further comprising:
receiving feedback on the updated output unit; and
updating the output unit based on the feedback, wherein the feedback comprises at least one of: how many and which answers to questions were answered correctly, data and behavioral information associated with interacting with the output unit time spent in certain modules of the output unit, results and durations of execution of certain tasks, or redirecting and accessing suggested links or videos.

4. (canceled)

5. (canceled)

6. A method of generating an educational output unit, the method comprising:
accessing, by a processor, content, wherein the content comprises information related to a subject;
receiving an input comprising a logic tree, wherein the logic tree comprises a structural hierarchy for the content;
analyzing, using a machine learning module, the content based on a logic tree;
generating a plurality of blocks, wherein the plurality of blocks comprises at least two blocks from different sections of the content;
associating tags with each block of the plurality of blocks; and
assembling the plurality of blocks into an output unit based on one or more parameters and the tags.

7. The method of claim 6, wherein the content comprises a plurality of works related to the subject, and wherein the output unit comprises the at least two blocks from different works.

8. The method of claim 6, wherein the output unit comprises a new work composed of the at least two blocks of the plurality of blocks.

9. The method of claim 6, further comprising:
sending the output unit to an evaluation unit;
updating, by the evaluation unit, the one or more parameters to generate updated parameters; and
updating the output unit using the updated parameters.

10. The method of claim 6, further comprising:
receiving feedback on the updated output unit; and
updating the output unit based on the feedback.

11. The method of claim 10, wherein the feedback comprises at least one of: how many and which answers to questions were answered correctly, data and behavioral information associated with interacting with the output unit time spent in certain modules of the output unit, results and durations of execution of certain tasks, or redirecting and accessing suggested links or videos.

12. The method of claim 10, further comprising:
generating a second output unit based on the feedback.

13. (canceled)

14. A method of generating an output unit, the method comprising:
receiving an input unit, wherein the input unit comprises content,
receiving input parameters, wherein the input parameters define need and objectives of multiple individual attendees or a group of attendees; and
generating an output unit based on the input unit and the input parameters.

15. The method of claim 14, wherein generating the output unit comprises:
generating a plurality of blocks from the input unit based on a hierarchical data structure; and
compiling a selection of blocks of the plurality of blocks based on the input parameters.

16. The method of claim 15, wherein generating the plurality of blocks comprises:
selecting a plurality of portions of the input unit;
classifying each portion of the plurality of portions using a machine learning model and the hierarchical data structure; and
tagging each portion of the plurality of portions with one or more identifiers, where each block of the plurality of blocks comprises each portion of the plurality of portions tagged with the one or more identifiers.

17. The method of claim 14, further comprising:
receiving a text string comprising one or more words;
formatting the one or more words within the text strings to generate search keys, wherein the search keys comprise text keys and phonetic keys;
searching a plurality of entities;
identify one or more results based on the searching;
receive a selection of at least one of the one or more results; and
incorporating the at least one of the one or more results into the output unit.

18. The method of claim 17, wherein the text keys and the phonetic keys are determined from the one or more words.

19. The method of claim 17, further comprising:
scoring the one or more results using the text keys and the phonetic keys; and
ranking the results based on the scoring, wherein the ranking based on the scoring is stored with the output unit.

20. (canceled)

21. A method of accessing a learning management system using a voice interface, the method comprising:
receiving, by an application programming interface (API) of a processing system, a command from a voice assistant, wherein the voice command is configured to respond to vocal input;
passing, from the API, the command to a websocket;
accepting, by the websocket, the command;
receiving, by the websocket, data associated with the command;
monitoring, by a system service of the processing system, the websocket;
accepting, by the system service, the command and data in response to the websocket accepting the command; and
performing the command using the data in response to accepting the command and data.

22. The method of claim 21, wherein performing the command comprises displaying data on a display or accessing a learning management system and displaying an output unit.

23. The method of claim 21, wherein the command is an HTTP call, and wherein the HTTP call comprises a device identification of the voice assistant and a user identification.

24. (canceled)

25. (canceled)

26. The method of claim 21, wherein the voice assistant is configured to accept the command in a plurality of languages.

27. The method of claim 21, wherein the command comprises at least one of: a command to access an output unit; a command to read an output unit; a command to reply to a question; a command to access the system and display information; a command to enable one or more functions; a command to search data by key-terms; a command to access a messaging system; a command to access a calendar, a command to read an incoming message; a command to send one or more messages; a command to read a list of appointments; a command to open a user's calendar on a system screen or display; a command to display on a system screen a last class that a user accessed; a command to display on a system screen an entity chosen by the user; or a command to send questions to a/teacher.

28. A method of providing an output unit comprising learning materials, the method comprising:
accessing a plurality of output units over an internet connection;
caching the plurality of output units in a local storage, wherein each output unit of the plurality of output units comprise learning materials;
ceasing the internet connection so that the internet connection is offline;
accessing and displaying one or more of the plurality of output units while the internet connection is offline; and
storing user input while the internet connection is offline.

29. The method of claim 28, further comprising:
restoring the internet connection;
comparing, using the internet connection, the plurality of output units in the local storage with a second plurality of output units in a remote storage;
synchronizing the plurality of output units and the second plurality of output units;
transferring the user input to the remove storage; and
providing at least one output unit of the second plurality of output units to a user using the internet connection.

30. The method of claim 28, further comprising:
disabling one or more services while the internet connection is offline; and
restoring the one or more services when the internet connection is restored.
